(19) United States
(12) Patent Application Publication
(10) Pub. No.: US 2026/0104929 A1
(43) Pub. Date: Apr. 16, 2026

(54) OPERATION-SPECIFIC CONTROL DATA

(71) Applicant: Arm Limited, Cambridge (GB)

(72) Inventors: Dominic Hugo SYMES, Cambridge (GB); Jens OLSON, San Jose, CA (US); Jared Corey SMOLENS, Santa Clara, CA (US); Rune HOLM, Oslo (NO)

(21) Appl. No.: 18/916,282

(22) Filed: Oct. 15, 2024

(51) Int. Cl. G06F 9/50

(52) U.S. Cl. CPC G06F 9/5027

(57) ABSTRACT

A processor comprising storage, execution circuitry and a handling unit. The handling unit is configured to obtain task data that describes a task to be executed. The task comprises a plurality of operations representable as a directed graph of operations comprising operations connected by connections corresponding to respective logical storage locations. In executing the task, the execution circuitry is configured to operate over a multi-dimensional nested loop. The task data comprises operation-specific control data for an operation of the operations, the operation-specific control data providing an indication, for each respective dimension of a plurality of dimensions of the multi-dimensional nested loop on a per-dimension basis, of whether the operation is to be executed for each iteration of a plurality of iterations over the respective dimension. The handling unit manages execution of the operation, using the execution circuitry, based on the operation-specific control data.

### BACKGROUND

### Technical Field

The disclosure herein relates to processors.

### Description of the Related Technology

Certain data processing techniques, such as neural network processing and graphics processing, involve the processing and generation of considerable amounts of data using operations. It is desirable to efficiently handle data such as this.

### SUMMARY

According to a first aspect of the present disclosure, there is provided a processor comprising storage, execution circuitry and a handling unit, the handling unit configured to: obtain task data that describes a task to be executed, the task comprising a plurality of operations representable as a directed graph of operations comprising operations connected by connections corresponding to respective logical storage locations, wherein, in executing the task, the execution circuitry is configured to operate over a multi-dimensional nested loop, and wherein the task data comprises operation-specific control data for an operation of the operations, the operation-specific control data providing an indication, for each respective dimension of a plurality of dimensions of the multi-dimensional nested loop on a per-dimension basis, of whether the operation is to be executed for each iteration of a plurality of iterations over the respective dimension; and manage execution of the operation, using the execution circuitry, based on the operation-specific control data.

### BRIEF DESCRIPTION OF THE DRAWINGS

FIG. 1a illustrates an example directed graph;

FIG. 1b is a schematic diagram of an example data processing system;

FIG. 2 is a schematic diagram of an example neural engine;

FIG. 3 is a schematic diagram of an example system for allocating handling data;

FIG. 4 is a table of an example of operation-specific control data and storage-specific control data and associated behaviors;

FIG. 5 is a schematic diagram of example storage;

FIG. 6 shows tables comprising various control data for a multi-dimensional nested loop; and

FIG. 7 shows schematically an example of use of the control data of FIG. 6 in executing the multi-dimensional nested loop; and

FIG. 8 is a schematic diagram of manufacture of a system and a chip-containing product.

### DETAILED DESCRIPTION

Examples herein relate to a processor comprising storage, execution circuitry and a handling unit. The handling unit may be implemented by handling circuitry. The handling unit is configured to obtain task data that describes a task to be executed. The task comprises a plurality of operations representable as a directed graph of operations comprising operations connected by connections corresponding to respective logical storage locations. In executing the task, the execution circuitry is configured to operate over a multi-dimensional nested loop.

The task data comprises operation-specific control data for an operation of the operations, the operation-specific control data providing an indication, for each respective dimension of a plurality of dimensions of the multi-dimensional nested loop on a per-dimension basis, of whether the operation is to be executed for each iteration of a plurality of iterations over the respective dimension. The handling unit manages execution of the operation, using the execution circuitry, based on the operation-specific control data.

The operation-specific control data may simplify control of the operation by indicating to the handling unit in a straightforward manner how the operation is to be executed. By indicating whether the operation is to be executed for each iteration on a per-dimension basis, the operation-specific control data may provide greater flexibility in the types of operation that can be managed by the handling unit, and executed by the execution circuitry. For example, the operation-specific control data can be used to signal, in a flexible and simple way, that the operation is to be executed for each iteration for certain dimension(s) of the multi-dimensional nested loop and that execution of the operation is not to be performed for each iteration of other dimension(s) of the multi-dimensional nested loop (e.g. that execution of the operation is to be performed for less than all of the iterations in each of these other dimension(s), such as one or no iterations in these dimension(s)).

For example, operation-specific control data such as this may facilitate the execution of operations that comprise updating data already stored within storage, such as by updating data stored within respective storage elements of a plurality of storage elements of the storage according to a predefined order, starting from an initial storage element of the plurality of storage elements, which may be referred to as “destination loopback” operations. For example, a matrix multiplication between two multi-dimensional tensors may involve the calculation of outer products, which include taking input data in turn and computing an intermediate result for each of many output locations, e.g. as an update to the data stored in a respective physical storage location corresponding to a respective output location, which may be performed based on the operation-specific control data herein. The input data may remain in the storage while the updates are computed and progressively written to the physical storage locations, which may reduce a number of fetches of the input data from further storage, which may require greater power to access.

Operation-specific control data may also or instead facilitate other operations, such as a consumption operation comprising reading of an intermediate block of intermediate data values generated by a production operation of the plurality of operations in determining a final block of final data values based on the intermediate block. For example, the handling unit can manage the execution of the production operation, based on the operation-specific control data, so as to maintain the intermediate block in the storage, rather than overwriting the intermediate block with the final block, to allow the intermediate block to be utilized by other operations such as the consumption operation. Operations such as this may be considered to include “loop-carry dependencies” or “previous iterations” as they involve the use of previously-generated intermediate blocks, which are e.g. generated by a previous iteration over a loop, such as a previous iteration of a loop of a multi-dimensional nested loop (described further below).

In general, the operation-specific control data may simplify the management of execution of directed graphs that comprise loops, multiple connections between operations in the directed graph and/or reading of blocks (which may be intermediate blocks or final blocks) at different rates by different operations. The operation-specific control data may thus be used by the handling unit to simplify the management of a wide range of different tasks, with various relationships between respective operations of the tasks.

### Execution of a Directed Graph

Many data structures to be executed in a processor can be expressed as a directed graph. Examples of such data structures include neural networks which can be represented as a directed graph of operations that wholly compose the operations required to execute a network (i.e. to execute the operations performed across the layers of a neural network). A directed graph is a data structure of operations (which may be referred to herein as ‘sections’) having directed connections therebetween that indicate a flow of operations. The connections between operations (or sections) present in the graph of operations may be referred to as pipes (where a given connection is the sole tenant of a particular region of the storage unit, which region may be allocated to that connection statically or dynamically) or sub-pipes (where a given connection shares a particular region of the storage unit with at least one other connection). The allocation of particular storage elements within a given region of the storage unit to different respective sub-pipes that are tenants of the given region of the storage unit may be performed dynamically. A plurality of sub-pipes may belong to the same pipe as each other, which may be referred to as a multi-pipe. In such cases, the multi-pipe may be the sole tenant of the given region of the storage unit, which may itself be statically or dynamically allocated to the multi-pipe. A directed graph may contain any number of divergent and convergent branches. A directed graph may contain any number of divergent and convergent branches.

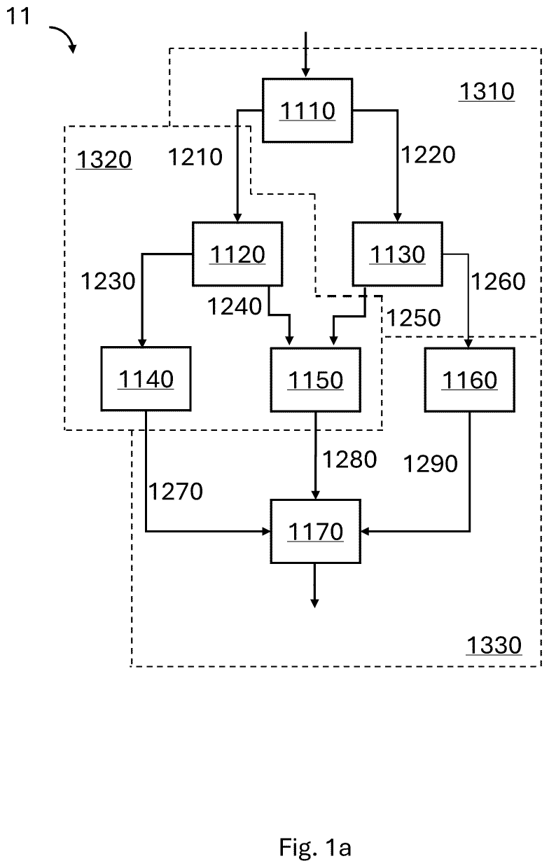

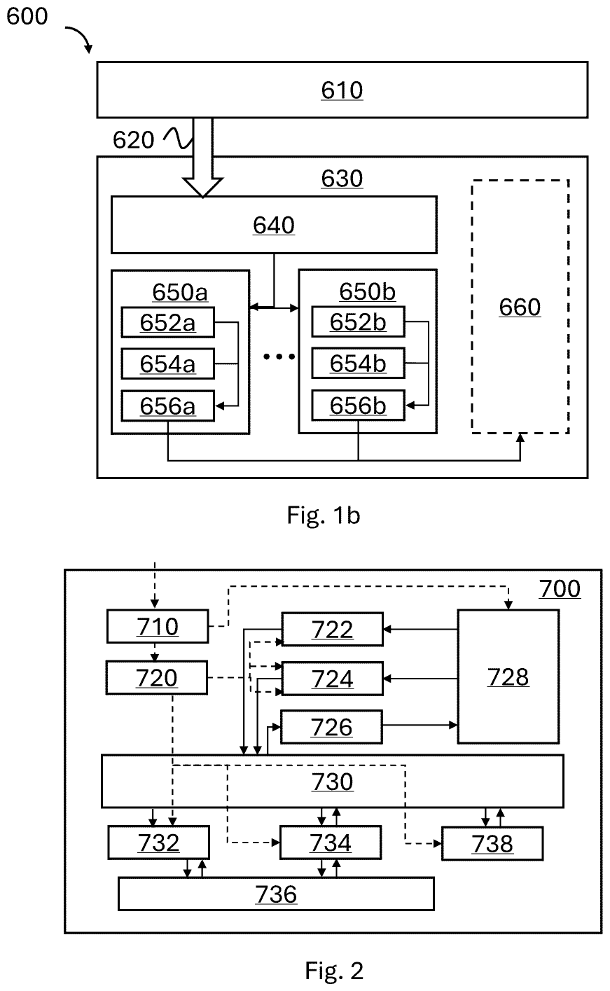

FIG. 1a illustrates an example directed graph 11 in which sections are interconnected by pipes or sub-pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe or sub-pipe. In FIG. 1a, sections 2 and 3 (1120, 1130) each write to different respective sub-pipes (1230, 1240, 1250, 1260) of the same pipe, pipe 3, which is a multi-pipe. Each sub-pipe has its own unique identifier, which also indicates the multi-pipe to which the sub-pipe belongs, where a multi-pipe is a pipe comprising at least one sub-pipe, as explained above. In this case, section 2 writes to sub-pipes 3.0 and 3.1 (1230, 1240) and section 3 writes to sub-pipes 3.2 and 3.3 (1250, 1260), where the numeral prior to the period indicates the identifier of the multi-pipe (3) and the numeral after the period indicates the identifier of the sub-pipe of the multi-pipe (0 to 3 in this case). A region of a storage unit is allocated to multi-pipe 3, and respective storage elements of the region of the storge unit are dynamically allocated to sub-pipes 3.0 to 3.3. In this example, different sections (sections 2 and 3) thus write to the same underlying physical region of the storage unit, via dynamically allocated sub-pipes.

The directed graph 11 of FIG. 1a also includes sections 4 to 6 (1140 to 1170) and pipes 4 to 6 (1270 to 1290). The sections 4 and 6 (1140, 1160) receive input data from sub-pipes 3.0 and 3.3 (1230, 1260) respectively, and write data to pipes 4 and 6 (1270, 1290) respectively. Section 5 (1150) in FIG. 1a receives a first set of input data via sub-pipe 3.1 (1240) from section 2 (1120) and a second set of input data via sub-pipe 3.2 (1250) from section 3 (1130) and writes data to pipe 5 (1280). Section 7 (1170) of the directed graph 11 receives input data from pipes 4 to 6 (1270 to 1290). Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 1a illustrates an arrangement where the graph 11 is broken down into three sub-graphs 1310, 1320, and 1330 which can be connected together to form the complete graph. For example, sub-graph 1310 contains sections 1 and 3 (1110 and 1130) as well as pipe 2 and sub-pipe 3.3 (1220 and 1260)), sub-graph 1320 contains section 2, 4 and 5 (1120, 1140, and 1150) as well as pipe 1 and sub-pipes 3.0 to 3.2 (1210, 1230, 1240, and 1250), and sub-graph 1330 contains sections 6 and 7 (1160 and 1170) as well as pipes 4 to 6 (1270, 1280, and 1290).

The operations performed when executing a neural network can be broken down into a sequence of operations forming a directed graph in the form described in respect of FIG. 1a. Examples herein provide flexibility in managing execution of various directed graphs of operations such as that shown in FIG. 1a.

### Convolution Operations

When executing progressions of operations, for example structured in a directed graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed.

It is desirable to define a set of pre-determined low-level operations from which a broad range of possible higher-level operations that correspond with various machine learning tool sets can be built. One example of such a low-level set of operations, is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUs, graphics processing units (GPUs) and custom hardware such as neural processing units/tensor processing units (NPUs/TPUs), with defined accuracy and compatibility constraints. Most operators from the common ML frameworks (TensorFlow, PyTorch, etc.) should be expressible in TOSA.

Many of the operations in a defined operation set (such as TOSA) can be represented as a loop of scalar operations. For example, consider a 2D convolution operation which can be expressed as a multi-dimensional loop of scalar operations. These may need to be executed on 2D input data having dimensions input X (IX) and input Y (IY):
(input) Input channel (IC)—a dimension representing the input channels upon which the operation is to be performed (in the example of images this may be three channels each representing one of red, green, and blue input channels)
(input) Kernel dimension X (KX)—a first dimension X of a 2D kernel;
(input) Kernel dimension Y (KY)—a second dimension Y of a 2D kernel;
(output) Output X (OX)—a first dimension of the output feature map for the convolution operation;
(output) Output Y (OY)—a second dimension of the output feature map for the convolution operation;
(output) Batch (N)—a batch dimension of the operation, where the operation is to be batched;
(output) Output channel (OC)—a dimension representing the output channels to be produced for the 2D convolution operation.

In one proposed ordering, KY/KX can be considered the inner-most dimensions and OC is the outer-most dimension.

For the 2D convolution operation example above, it is possible to express the operation to be performed as a “nested for-loop” of scalar operations as is illustrated in the pseudo-code set out below. In practice, when executing this operation, it is necessary for a processor to execute the operation across each of these dimensions by performing a multiple-accumulate operation (MAC), the result of which is then written into an accumulator (e.g. an accumulator buffer in hardware). Having operated through all of these dimensions, the 2D convolution is completed and the contents of the accumulator therefore represents the result of the 2D convolution operation across the entire dimensionality of operation.

```
for(output channel)
  for(batch N)
    for(output Y)
      for(output X)
        for(input channel)
          for(kernel Y)
            for(kernel X)
              MAC
              write accumulator
```

For the 2D convolution, the MAC operation is performed for each iteration over the nested for-loop, as the MAC operation is performed in the innermost loop of the nested for-loop. However, for other operations that can be managed according to the operation-specific control data described herein, the operation may be performed in a loop other than the innermost loop and/or may be performed for a sub-set of iterations of a given loop, such as solely for the first or last iteration of the loop.

Operations such as the 2D convolution operation described above can be separated into operation blocks, each operation block representing a subset of an operation in which each dimension of the operation block covers a subset of the full range of the corresponding dimension in the operation. For example, the 2D convolution described above can be separated into multiple operation blocks by breaking up the operation in the OY, OX, and IC dimensions.

### Hardware Implementation

As described above, a data structure in the form of a directed graph may comprise plural sequenced operations that are connected to one another for execution in a progression. Described below is an example hardware arrangement for executing linked operations for at least a portion of a directed graph as illustrated in FIG. 1a.

FIG. 1b shows schematically an example of a data processing system 600 including a processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing Units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable to utilize some of the GPU's existing resources (e.g. such that at least some functional units and resources of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor means that the machine learning processing circuit may then be operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 1b, the processor 630 is arranged to receive task data 620 from a host processor 610, such as a central processing unit (CPU). The task data comprises at least one command in a given sequence, each command to be executed, and each command may be decomposed into a number of tasks, such as tasks discussed in this disclosure. These tasks may be self-contained operations, such as a given machine learning operation or a graphics processing operation. It will be appreciated that there may be other types of tasks depending on the command.

The task data 620 is sent by the host processor 610 and is received by a command processing unit 640 which is arranged to schedule the commands within the task data 620 in accordance with their sequence. The command processing unit 640 is arranged to schedule the commands and decompose each command in the task data 620 into at least one task. Once the command processing unit 640 has scheduled the commands in the task data 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second tasks may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access to data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the task data 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher-level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBA®) interface, such as the Advanced eXtensible Interface (AXI), may be used.

FIG. 2 is a schematic diagram of a neural engine 700, which in this example is used as a first processing module 652a, 652b in a data processing system 600 in accordance with FIG. 1b. The neural engine 700 includes a command and control module 710. The command and control module 710 receives tasks from the command processing unit 640 (shown in FIG. 1b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a progression of operations representing a sequence of layers of the neural network. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 732, a vector engine 734, a transform unit 738, an accumulator buffer 736, and a shared storage 730, for processing of blocks of data. The data dependencies across the functional units are tracked by the handling unit 720. Processing is initiated by the handling unit 720 in a functional unit if all input blocks are available and space is available in the shared storage 730 of the neural engine 700. The shared storage 730 may be considered to be a shared buffer, in that various functional units of the neural engine 700 share access to the shared storage 730.

In the context of a directed graph representing the operations to be performed, each of the internal components that operates upon data can be considered to be one of two types of component. The first type of component is an execution unit (and is identified within the neural engine 700 as such) that maps to a section that performs a specific instance of an operation within the directed graph. For example, the weight fetch unit 722, input reader 724, output writer 726, dot product unit array 732, vector engine 734, transform unit 738 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The handling unit 720 is configured to allocate storage elements to respective connections in the directed graph, which can correspond to pipes as explained above. For example, portions of the accumulator buffer 736 and/or portions of the shared storage 730 can each be regarded as a storage element that can act to store data for a pipe or a sub-pipe within the directed graph, as allocated by the handling unit 720. A pipe or a sub-pipe can act as a connection between sections (as executed by execution units) to enable a sequence of operations as defined in the directed graph to be linked together within the neural engine 700. Put another way, the logical dataflow of the directed graph can be mapped to the physical arrangement of execution units and storage elements within the neural engine 700. Under the control of the handling unit 720, execution can be scheduled on the execution units and data can be passed between the execution units via the storage elements in accordance with the mapping, such that the linked operations of a graph can be executed without needing to write data memory external to the neural engine 700 between executions. The handling unit 720 is configured to control and dispatch work representing performing an operation of the graph on at least a portion of the data provided by a pipe or a sub-pipe.

The weight fetch unit 722 fetches weights associated with the neural network from external storage and stores the weights in the shared storage 730. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 732, vector engine 734 and transform unit 738 to generate output data corresponding to an operation in the directed graph. The result of each operation is stored in a specific pipe or sub-pipe within the neural engine 700. The DPU array 732 is arranged to perform one or more operations associated with a dot product operation between two operands, such as between an array of weights and a corresponding block of data (e.g. representing part of a tensor). The vector engine 734 is arranged to perform elementwise operations, for example to apply scale parameters to scale an output of a dot product calculated by the DPU array 732. Data generated during the course of the processing performed by the DPU array 732 and the vector engine 734 may be transmitted for temporary storage in the accumulator buffer 736 from where it may be retrieved by either the DPU array 732 or the vector engine 734 (or another different execution unit) for further processing as desired.

The transform unit 738 is arranged to perform in-block transforms such as dimension broadcasts or axis swaps. The transform unit 738 obtains data (e.g. after processing by the DPU array 732 and/or vector engine 734) from a pipe or a sub-pipe, for example mapped to at least a portion of the shared storage 730 by the handling unit 720. The transform unit 738 writes transformed data back to the shared storage 730.

To make efficient use of the shared storage 730 available within the neural engine 700, the handling unit 720 determines an available portion of the shared storage 730, which is available during execution of part of a first task (e.g. during processing of a block of data associated with the first task by the DPU array 732, vector engine 734 and/or transform unit 738). The handling unit 720 determines a mapping between at least one logical address associated with data generated during execution of a second task (e.g. by processing of a block of data associated with the second task by the DPU array 732, vector engine 734 and/or transform unit 738) and at least one physical address of the shared storage 730 corresponding to the available portion. The logical address is for example a global address in a global coordinate system. Hence, by altering the physical address corresponding to a given logical address, the handling unit 720 can effectively control usage of the shared storage 730 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

In an analogous manner, the handling unit 720 can determine a mapping between logical storage locations (e.g. corresponding to respective logical addresses) corresponding to respective connections within the directed graph and sets of storage elements (e.g. corresponding to sets of physical addresses within storage of the neural engine 700, such as within the accumulator buffer 736 and/or the shared storage 730). In this way, the handling unit 720 can for example dynamically allocate first and second sets of storage elements to correspond to first and second logical storage locations associated with first and second operations (e.g. first and second sections) of the directed graph.

The handling unit 720 can for example allocate respective physical storage locations (e.g. corresponding to respective storage elements of the storage of the neural engine 700, such as respective buffers of the accumulator buffer 736 and/or the shared storage 730) for storing respective blocks generated by an operation of the directed graph, such as by a production operation. For example, the handling unit 720 can allocate a physical storage location for storing an intermediate block of intermediate data values generate by the production operation in determining a final block of final data values based on the intermediate block. In allocating the physical storage locations, the handling unit 720 may map logical storage locations (e.g. corresponding to respective logical addresses) corresponding to respective connections within the directed graph to respective sets of storage elements. The mapping may be performed dynamically by the handling unit 720, to utilize the storage of the neural engine 700 more efficiently.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements and/or between sub-pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes and/or sub-pipes.

All storage in the neural engine 700 may be mapped to corresponding pipes and/or sub-pipes, including look-up tables, accumulators, etc., as discussed further below. The width and height of pipes and/or sub-pipes can be programmable, resulting a highly configurable mapping between pipes, sub-pipes and storage elements within the neural engine 700.

Ordering of execution of the sections is implied by dependencies on inputs. A memory load operation has no data dependencies (unless it is a gather operation), so is implicitly early in the graph. The consumer of the pipe (or sub-pipe) that the memory read produces is implicitly after the memory read. A memory store operation is near the end of the graph, as it produces no pipes or sub-pipes for other operations to consume. The sequence of execution of a progression of operations is therefore handled by the handling unit 720 as will be explained in more detail later.

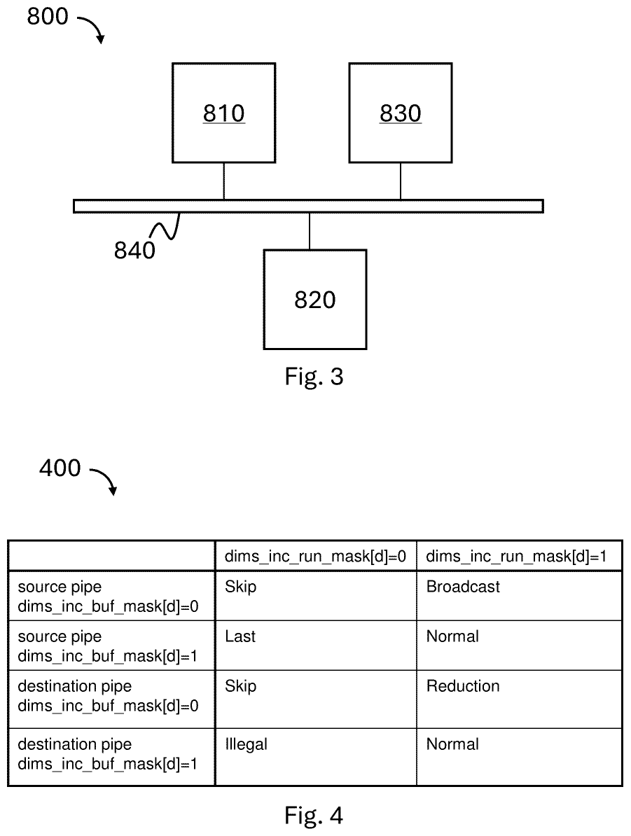

FIG. 3 shows schematically a system 800 for allocating handling data, and in some examples generating a plurality of blocks of input data for processing.

The system 800 comprises host processor 810 such as a central processing unit, or any other type of general processing unit. The host processor 810 issues task data comprising a plurality of commands, each having a plurality of tasks associated therewith.

The system 800 also comprises a processor 830, which may be similar to or the same as the processor 630 of FIG. 1b and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBAR) interface, such as the Advanced extensible Interface (AXI), may be used.

### Neural Engine Program Descriptor (NED)

As explained above, the neural engine 700 receives tasks from the command processing unit 640 to execute operations from the directed graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of task data processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issued by the command processing unit. The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes and/or sub-pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes and/or sub-pipes. In one implementation, each of the execution units and each storage element (or portion of a storage element) of the neural engine 700 has a sub-descriptor definition which defines how that execution unit/storage element can be configured for use in implementing a specific section, pipe or sub-pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The dataflow and dependencies of the task's graph is described by pipes and/or sub-pipes. Pipes and/or sub-pipes are used to represent data storage elements within the neural engine 700 and describe the relationship between sections (operations) in a producer-consumer relationship: the output destination pipe or sub-pipe (e.g. a pipe or sub-pipe number) and each input source pipe or sub-pipe (e.g. a pipe or sub-pipe number) for every section is defined in the NED elements of the NED. Pipes and sub-pipes each have only a single producer but may have multiple consumers. A pipe and/or a sub-pipe may be mapped to one of several different physical storage locations (e.g. storage units in the neural engine 700), but not all physical storage locations may be suitable for the different section operations. It will be appreciated that, in some arrangements, a pipe may be mapped to only a portion of a storage unit, which may include at least one storage element. For example, a physical buffer (or a set of physical buffers, which may be or form part of a memory bank) may be considered to be a storage unit, and a physical address (or a set of physical addresses) corresponding to or within a physical buffer may be considered to be a storage element. For example, a storage unit may correspond to a set of physical buffers and a storage element may be a physical buffer of the set of physical buffers, the physical buffer comprising a set of physical addresses. In such cases, a pipe and/or a sub-pipe can describe double-buffering (for example) behavior between its producer and consumers. The output data generated by a section and stored in a pipe or a sub-pipe is referred to equivalently as both a block (of data) and a (virtual) buffer, with a block of data occupying one physical buffer location. Irrespective of location, pipes and/or sub-pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input. In examples, though, the NED may be configured such that each sub-pipe has a single producer.

In some embodiments, sections such as InputReader and WeightFetcher have no input pipes and/or sub-pipes and instead their data comes from external memory, such as an external cache or DRAM. By contrast, some sections, such as OutputWriter have no output pipes or sub-pipes. In this case, their data is written to external memory.

For a section to run, it must have all the appropriate buffers available for its input source pipes and/or sub-pipes. A section may produce a new buffer in its output destination pipe or sub-pipe and so there must be space available in the pipe or sub-pipe for this new buffer. The neural engine 700 is responsible for tracking all of these dependencies.

The NED is split into multiple data structures that may appear contiguously in memory to be read by the neural engine 700. In this example implementation, the NED header defines the dimensions of the operation space of the operations to be performed. Specifically, the NED header defines the total size of the NED (e.g. number of bytes to be used to represent the NED) as well as a count of the number of section and pipes that are present in the graph.

For each section and pipe in the graph, a count of a corresponding mapped sub-descriptor element types is represented in the NED header. For instance, where the graph (or sub-graph) contains a number of sections, each of those sections is to be executed on a particular compatible execution unit of the neural engine 700. For each section, an element of the appropriate type is therefore counted in the NED header in order to represent the hardware requirements needed to invoke execution of the graph. For example, for a section that defines a convolution operation, a corresponding configuration and invocation of a convolution engine execution unit would be required. Similar counts of instantiations of weight fetch and input read execution units are counted based on the presence of sections that use those operations. This is reflected in the count in the NED header against the weight fetch and input reader elements associated with the weight fetch and input reader units in the neural engine 700.

The NED also contains information that describes any divergent or convergent branches between sections and pipes. For example the NED identifies, for each pipe in the graph, the number of producers and consumers associated with that pipe.

The NED header therefore essentially identifies the operation space and a count of all instances of sections and pipes (for each type of hardware element that is to be allocated for instantiating a section or a pipe that will be required to execute the graph (or sub-graph)) defined by the NED. An illustrative example of at least a portion of the fields stored in the NED header is set out below. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

An example of at least some of the fields in a NED header is set out below:

| Field | Min | Max |
|---|---|---|
| Operation space size for dimension 1 | — | — |
| Operation space size for dimension 2 | — | — |
| Operation space size for dimension 3 | — | — |
| Operation space size for dimension 4 | — | — |
| Operation space size for dimension 5 | — | — |
| Operation space size for dimension 6 | — | — |
| Operation space size for dimension 7 | — | — |
| Operation space size for dimension 8 | — | — |
| Operation space size for dimension 9 | — | — |
| Operation space size for dimension 10 | — | — |
| Operation space size for dimension 11 | — | — |
| Number of weight fetch and decode sections | 0 | 1 |
| Number of input reader sections | 1 | 7 |
| Number of output write sections | 1 | 7 |
| Number of convolution engine sections | 0 | 7 |
| Number of transform unit sections | 0 | 7 |
| Number of vector engine sections | 0 | 7 |
| Number of pipes | 1 | 15 |

The theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine. A practical approach to defining a task and its corresponding operation space is set out in more detail later.

The NED header may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D-namely [oc, n, oy, ox, ic, ky, kx].

Field

Stride X and Stride Y
Dilation X and Dilation Y
Operation type (e.g. which type of convolution
operation is to be performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

In this example implementation, pipes represent all storage within the neural engine: all allocation and memory management is handled through a task's NED Pipe definitions and the traversal through the sections that produce and consume these pipes. There is no sharing of pipes between tasks and therefore no architected sharing of data between tasks within the neural engine. A sub-descriptor element is defined in the NED for each pipe in the graph. An example of a pipe sub-descriptor is set out below:

| Field | Min | Max |
|---|---|---|
| Pipe location (e.g. accumulator buffer, | 0 | 2 |
| shared buffer, LUT memory) | | |
| Number of buffers occupied by the pipe | 1 | 16 |
| Starting bank in memory | 1 | 8 |
| Number of banks used by the pipe | 1 | 8 |
| Starting word | 0 | 255 |
| Number of words per buffer | 1 | 256 |

As will be described in more detail later, these descriptors are used to configure the hardware elements when invocation is triggered by the handling unit 720.

### Neural Engine Dimensions and Iteration

In examples, a neural engine task describes a 12D bounding box with dimensions numbered from 0 to 11. The task data provides a pointer to a NED, which defines the section operations of the directed graph representing the task. The bounding box for the dimension may be a sub-region of the full size of these dimensions. Different tasks and/or jobs may cover other sub-regions of these dimensions. As illustrated in FIGS. 1b and 2, the command processing unit 640 may issue different tasks to different neural engines. The NED additionally defines an increment size for each of the dimensions to be stepped through, known as a block size. Execution of the graph against this 12D operation-space can be considered as a series of nested loops.

This splits the execution of the task's operation-space into a series of blocks, with sections being invoked on a block-by-block basis, operating on a block's worth of data in every source and destination pipe. Consequently, defining a general operation space in a coordinate system having for example 12 dimensions may provide a low complexity pattern for execution of any task comprising operations on data, instead of relying on fixed functions per task type, which may encompass a significant risk of missing necessary combinations of patterns. By defining a common operation space in a coordinate space, it may be less complex to chain a plurality of operations to be executed on data to each other and coordinate execution of these functions. Operation space dimensions do not have a specific interpretation until they are projected into space for a specific task.

The number of dimensions in use is dependent on the graph and its operations; not every section will run for increments (i.e. iterations) in each dimension. For example, a convolution operation has a 7D operation-space but only a 4D output space through which the convolution operation increments and accumulates output; a VE scaling operation following a convolution thus only runs for increments in the first four dimensions.

In examples herein, the task data (e.g. representing the NED) comprises operation-specific control data for a particular operation, which provides an indication, for each respective dimension of a plurality of dimensions of the multi-dimensional nested loop on a per-dimension basis, of whether the operation is to be executed for each iteration of a plurality of iterations over the respective dimension. The operation-specific control data may provide greater flexibility in controlling execution of the operation than other approaches, such as those indicating a number of dimensions for which the operation is to be executed for each iteration over without specifying which of the dimensions the operation is to be executed for each iteration over.

The operation-specific control data may comprise a mask to provide the indication for each respective dimension of the plurality of dimensions. A mask may be a compact and efficient way of providing the indication. As the operation-specific control data provides the indication on a per-dimension basis, execution of the operation for each iteration can be triggered for various dimensions as desired by setting the value of the mask for each dimension accordingly. The mask may be a bit-wise mask comprising an element per dimension of the plurality of dimensions, a state of each element of the bit-wise mask providing the indication, on the per-dimension basis. Such a mask may provide the indication in a simple manner, which may be readily interpreted by the handling unit and used to manage execution of the operation by the execution circuitry.

In an example in which the neural engine task describes a 12D bounding box, the mask is a 12-bit mask, dims_inc_run_mask (a “dimensions increment run mask”), which is encoded in a NED element. The dims_inc_run_mask for a given section may be considered to define for which operation-space dimensions the section is run on each increment. For example, the state of each element of the mask provides an indication of whether changes of coordinate in the dimension corresponding to that element causes the operation to execute. In other words, the state indicates whether the operation is to be executed for iterations over that dimension. For a given dimension, the state for example takes a value of 0 (indicating that the operation is not to be executed for each of a plurality of iterations over the given dimension) or 1 (indicating that the operation is to be executed for each of the plurality of iterations, such as for each operation-space step through the given dimension). For a value of 0, this may indicate that the operation is only to be executed for a particular iteration over the given dimension, such as for the first or last iteration, or that the operation is not dependent on the given dimension, e.g. based on at least one other control parameter such as storage-specific control data, discussed further below.

There may be any correspondence between elements of the mask and respective dimensions. For example, the rightmost element of the mask may correspond to the outermost dimension, with each subsequent element of the mask in a leftward direction corresponding to the next dimension in the nested loop, in an inwards direction, so that the leftmost element corresponds to the innermost dimension, or vice versa. For example, with the rightmost element of the mask corresponding to the outermost dimension and the leftmost element corresponding to the innermost dimension, a mask with an example value of 0b000000001111 indicates that the operation is to be executed for each iteration of a plurality of iterations of each of the four outermost dimensions, and that the operation is not to be executed for each iteration of the remaining dimensions. In other examples, though, the dimensions for which the operation is to be executed for each iteration for need not be consecutive dimensions within the nested loop.

The task data (e.g. representing the NED) may further comprise storage-specific control data for a connection between the operation and a further operation adjacent to the operation within the directed graph. The storage-specific control data is configured to provide a further indication, for each respective dimension of the plurality of dimensions on a per-dimension basis, of whether usage of the storage is iteration-dependent. By providing the further indication on a per-dimension basis, the storage-specific control data may provide additional support and/or flexibility for various operations, such as those involving destination loop-back, previous iterations and so forth.

The storage-specific control data may comprise a further mask to provide the further indication for each respective dimension of the plurality of dimensions, which may be a relatively compact way of providing the further indication. The mask may be a further bit-wise mask comprising an element per dimension of the plurality of dimensions, a state of each element of the further bit-wise mask providing the further indication, on the per-dimension basis, which may provide the further indication straightforwardly. For a given dimension, the state for example takes a value of 0 (indicating that usage of the storage is iteration-independent) or 1 (indicating that usage of the storage is iteration-dependent). For example, for storage corresponding to a destination pipe, to which blocks of data generated in executing the operation is to be stored, a value of 0 may indicate that a new buffer is not to be generated for the destination pipe for each iteration over the given dimension and a value of 1 may indicate that a new buffer is to be generated for the destination pipe for each iteration over the given dimension.

In an example, the further mask is also a 12-bit mask, similar to the dims_inc_run_mask, which may be referred to as dims_inc_buf_mask (a “dimensions increment buffer mask”), which is encoded in a NED element. The dims_inc_buf_mask for a given section may be considered to define for which operation-space dimensions there is a new pipe buffer on each increment (for source or destination pipes) and thus whether usage of the storage depends on which iteration is being executed (e.g. whether different iterations are associated with different buffers or not). A state of each element of the further mask provides the indication of whether usage of the storage is iteration-dependent for a given dimension. Usage of the storage may be considered iteration-dependent for the given dimension in examples in which data is read from or written to a different physical storage location for different iterations in the given dimension. For example, for an operation comprising writing data to storage, usage of the storage may be considered iteration-dependent if a new block (stored in a new physical storage location of the storage) is generated in the pipe when the given dimension is incremented in execution the operation (such as a production section), rather than overwriting an existing block in an existing physical storage location. Similarly, for an operation comprising reading data from storage (such as a consumption section), usage of the storage may be considered iteration if blocks are read from different physical storage locations for different iterations over the given dimension in executing the operation. As for the mask, there may be any correspondence between elements of the further mask and respective dimensions, which may be the same as that for the mask or different.

For a given dimension of the plurality of dimensions, a combination of the indication and the further indication may encode a behavior associated with the given dimension in executing the operation. In this way, particular behaviors can be signaled in a more streamlined and unified way by the dims_inc_run_mask and/or dims_inc_buf_mask values compared to other approaches in which different behaviors are each associated with their own respective control data. In this way, the handling unit can manage execution of the behavior for the given dimension, using the execution circuitry, based on the operation-specific control data and the storage-specific control data.

The table 400 shown in FIG. 4 illustrates an example of operation-specific control data for an operation and storage-specific control data for a connection between the operation and an adjacent operation in the directed graph. The table 400 further shows the behavior encoded by particular combinations of values for the operation-specific control data and the storage-specific control data for a given dimension.

In the table 400, the combination of the operation-specific control data providing an indication that the given dimension (indicated by the parameter d) is to be iterated over (dims_inc_run_mask [d]=1) and the storage-specific control data providing a further indication that the usage of the storage is iteration-dependent (dims_inc_buf_mask [d]=1) encodes the behavior that each iteration of the plurality of iterations is associated with a different respective physical storage location of the storage.

If dims_inc_buf_mask [d]=1 for a source pipe (from which data is to be read in executing the operation, and corresponding to a connection between the operation and a production operation configured to produce the data to be read in executing the operation), the behavior is indicated in the table 400 as “Normal” in this example. The source pipe for example corresponds to a set of source logical source locations. The “Normal” behavior of the table 400 for a source pipe corresponds to the section (i.e. operation) running for each increment (i.e. iteration) in the given dimension and the source pipe incrementing for each increment in the given dimension. In this way, each iteration in the given dimension comprises reading different source data. To manage this, the handling unit may map respective source logical storage locations of the set of source logical storage locations, corresponding to different respective iterations of the plurality of iterations, to different respective source physical storage locations and instruct the execution circuitry to iterate over the given dimension, comprising reading source data stored in different respective source physical storage locations for each of the plurality of iterations. For example, each source physical storage location may be a buffer of storage of the processor comprising the handling unit, so that the set of source logical storage locations corresponding to the source pipe are mapped to a corresponding set of buffers by the handling unit, a different one of which is read for each iteration over the given dimension.

If dims_inc_buf_mask [d]=1 for a destination pipe (to which data is to be written in executing the operation, and corresponding to a connection between the operation and a consumption operation comprising reading data generated in executing the operation), the behavior is indicated in the table 400 as “Normal” in this example. The destination pipe for example corresponds to a set of destination logical source locations. The “Normal” behavior of the table 400 for a destination pipe corresponds to the section (i.e. operation) running for each increment (i.e. iteration) in the given dimension and the destination pipe incrementing for each increment in the given dimension. In this way, each iteration in the given dimension comprises executing the operation and writing the data generated (e.g. in the form of a block of data) to a different respective physical storage location. To manage this, the handling unit may map respective destination logical storage locations of the set of destination logical storage locations, corresponding to different respective iterations of the plurality of iterations, to different respective destination physical storage locations and instruct the execution circuitry to iterate over the given dimension, comprising, for each respective iteration of the plurality of iterations, writing data generated in executing the respective iteration to a different respective destination physical storage location. For example, each destination physical storage location may be a buffer of storage of the processor comprising the handling unit, so that the set of destination logical storage locations corresponding to the destination pipe are mapped to a corresponding set of buffers by the handling unit, so that data generated in each iteration is written to a different respective buffer.

Table 400 illustrates a further combination in which the operation-specific control data provides an indication that the given dimension is to be iterated over (dims_inc_run_mask [d] =1) and the storage-specific control data provides a further indication that the usage of the storage is iteration-independent (dims_inc_buf_mask [d]=0). If the connection associated with the storage-specific control data corresponds to a set of source logical storage locations, i.e. so that dims_inc_buf_mask [d]=0 for a source pipe, the behavior is indicated in the table as “Broadcast”. This corresponds to the section (i.e. operation) running for each increment (i.e. iteration) in the given dimension and the pipe not incrementing so as to broadcast data stored in the source pipe. The source pipe is thus re-used and is e.g. consumed multiple times. The source pipe may be re-used through one or more operation-space dimensions. For example, the feature map input to a convolution operation is typically re-used against the weight kernel x and y dimensions of the convolution engine. This behavior may be performed provided dims_inc_buf_mask [k]=0 for k>=d.

In order to manage the execution of “Broadcast” behavior in response to these values of the operation-specific control data and the storage-specific control data (for a given source pipe), the handling unit is for example configured to map a source logical storage location of the set of source logical storage locations to the same source physical storage location for each iteration of iteration of the plurality of iterations and instruct the execution circuitry to repeatedly re-read source data from the same source physical storage location in iterating over the given dimension. For example, each source physical storage location may be a buffer of storage of the processor comprising the handling unit, so that the set of source logical storage locations corresponding to the source pipe are mapped to a corresponding set of buffers by the handling unit. Data stored within this set of buffers is then re-read repeatedly to execute the operation.

In the table 400, if the connection associated with the storage-specific control data corresponds to a set of destination logical storage locations (i.e. a destination pipe), dims_inc_run_mask [d]=1 (i.e. the given dimension is to be iterated over) and dims_inc_buf_mask [d]=0 (i.e. usage of the storage is iteration-independent) for the destination pipe, this encodes the behavior of “Reduction”. This corresponds to the section (i.e. operation) running on increments (i.e. iterations) over the given dimension but the destination pipe not incrementing for iterations over the given dimension. In an example, reduction means that data from at least one inner dimension of the nested loop are accumulated in a smaller number of outer dimensions (with the section reading back and updating the destination pipe over multiple invocations). For example, a vector block reduction operation will result in a smaller number of buffer increments. This behavior may be performed provided that dims_inc_buf_mask [k]=0 for k>=d and the operation is a reduction operation.

To manage the execution of “Reduction” behavior in response to these values of the operation-specific control data and the storage-specific control data (for a given destination pipe), the handling unit is for example configured to map a destination logical storage location of the set of destination logical storage locations to the same destination physical storage location for each iteration of the plurality of iterations and instruct the execution circuitry to repeatedly write destination data to the same destination physical storage location in iterating over the given dimension. For example, each destination physical storage location may be a buffer of storage of the processor comprising the handling unit, so that a destination local storage location is mapped to the same buffer by the handling unit so that the data within the buffer is repeatedly updated, for each iteration of the given dimension, with data generated by the respective iteration.

In the table 400, if the connection associated with the storage-specific control data corresponds to a set of source logical storage locations (i.e. a source pipe), dims_inc_run_mask [d] =0 (i.e. the iteration over the given dimension is to be omitted) and dims_inc_buf_mask [d]=1 (i.e. usage of the storage is iteration-dependent) for the source pipe, this encodes the behavior of “Last”. This corresponds to the section (i.e. operation) not running until the final iteration over the given dimension. The storage is read from in executing the final iteration, but is not read from prior to this. To manage this, the handling unit may suppress execution of the operation, by the execution circuitry, for the given dimension for iterations prior to a final iteration of the plurality of iterations, map a source logical storage location of the set of source logical storage locations to a source physical storage location for the final iteration and instruct the execution circuitry to execute the final iteration, comprising reading source data stored in the source physical storage location.

For example, the handling unit may allocate different respective source physical storage locations for different respective iterations over the given dimension and keep track of these source physical storage locations, e.g. by creating a data structure such as a linked list comprising a series of pointers to each of these source physical storage locations. The handling unit may traverse this data structure during iterations over the given dimension. However, as the section is only executed at the final iteration, the handling unit may perform a “dummy issue” for iterations prior to the final iteration, in which the data structure is traversed for each of these iterations but without issuing instructions to the execution circuitry to read the data at the physical storage location for the respective iteration (and/or with such instructions suppressed). Upon reaching the final iteration, the handling unit may then, based on the operation-specific control data and the storage-specific control data, issue execution instructions to the execution circuitry to cause the execution circuitry to execute the operation for the final iteration, comprising reading the source data stored in the source physical storage location for the final iteration. This is merely an example, though, and in other cases the handling unit may manage execution of sections such as this in a different manner, e.g. using a linked list comprising a set of pointers indicative of physical storage locations associated with each iteration over the given dimension and a further set of pointers indicative of solely the physical storage locations for final iterations over the given dimension.

In the table 400, if dims_inc_run_mask [d]=0 (i.e. iteration over the given dimension is to be omitted) and dims_inc_buf_mask [d]=0 (i.e. usage of the storage is iteration-independent) for a source pipe or a destination pipe, this encodes the behavior of “Skip”. This corresponds to the section (i.e. operation) not running on increments (i.e. iterations) in the given dimension and the pipe not incrementing in the given dimension. To manage this, the handling unit may suppress execution of the operation, by the execution circuitry, for the given dimension, for example by suppressing instructions to the execution circuitry and/or by omitting the sending of such instructions, so that the execution circuitry is not caused to execute the operation. For these skipped dimensions, the operation space block position may be set to the first iteration position in these dimensions.

The table 400 also illustrates that the combination of dims_inc_run_mask [d]=0 and dims_inc_buf_mask [d]=1 for a destination pipe is illegal because a physical storage location such as a buffer must have a producer. The handling unit may thus suppress execution of the operation for the given dimension if this combination of values is provided to the handling unit for that dimension.

### Storage Allocation

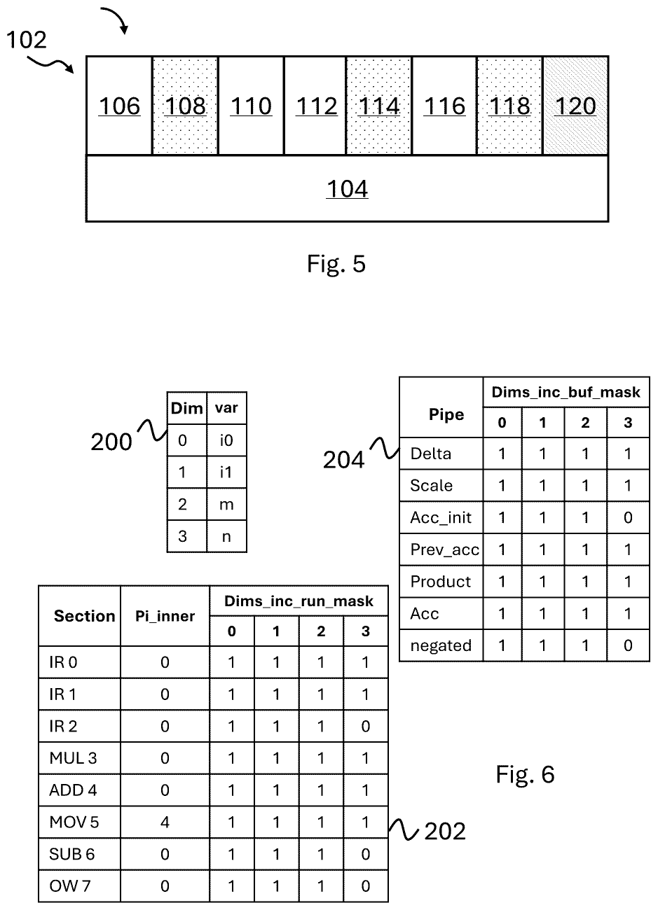

As explained above, the handling unit in examples allocates physical storage locations to correspond to logical storage locations corresponding to connections in a directed graph of operations based on operation-specific control data and, in some cases, storage-specific control data. Allocation of respective storage elements (e.g. corresponding to physical storage locations or parts thereof) to different sub-pipes by the handling unit 720, for example in a dynamic manner, will now be described in more detail, with reference to FIG. 5.

FIG. 5 illustrates schematically storage 100 comprising two storage units 102, 104 each corresponding to a respective set of buffers, according to a simplified example. Each storage unit 102, 104 comprises eight buffers, each corresponding to a different respective storage element. Each of the storage elements corresponds to a different respective physical location within the storage unit 102, 104. The eight storage elements are labelled with reference numerals 106-120 for the first storage unit 102 and omitted for the second storage unit 104, for clarity. The storage 100 of FIG. 5 may be used as storage of or accessible to the neural engine 700 of FIG. 2, such as the accumulator buffer 736 or the shared storage 730 (which may be referred to herein as a shared buffer). It is to be appreciated that the example of FIG. 5 is merely illustrative and in other cases a storage may include more or fewer storage units than two, a storage unit may be a different physical area of a storage than a set of buffers, a storage element may be a different component of a storage unit than a buffer and/or a storage unit may include more or fewer storage elements than eight.

In an example in which the storage 100 is used as the accumulator buffer 736, the storage 100 may be a high bandwidth SRAM static random access memory, which may be used to pass data between the convolution engine and the vector engine. The storage 100 may be partitioned such that portions of the convolution engine selectively communicate with specific banks of the storage 100, respectively. This may reduce data routing and simplify the physical structure of the storage 100. The accumulator buffer 736 in this example is smaller than the shared storage 730 and therefore consumes less power per access than the shared storage 730. In a particular example, the accumulator buffer 736 comprises two buffers of 16K 32-bit accumulators each, such as two of the buffers 106-120 shown in the illustrative example of FIG. 5.

In examples, a directed graph represented by task data may include a plurality of convolution engine sections in a chain. To accommodate this, the accumulator buffer 736 could be increased relative to a size for accommodating a single convolution engine section. However, this would increase the physical area of the hardware occupied by the accumulator buffer 736 and increase the power consumption for accessing data within the accumulator buffer 736. Hence, in examples herein, different sets of storage elements of a given storage unit (the first storage unit 102 in FIG. 5) are dynamically allocated to correspond to different logical storage locations, corresponding to different sub-pipes, for storing respective outputs of different operations, corresponding to different sections. This allows multiple sections to write to the same physical storage (in this case, to the same storage unit 102). Each sub-pipe (corresponding to a respective set of storage elements) in these examples has a single producer and at least one consumer (where the producer and at least one consumer are respective sections of the directed graph). Sub-pipes may thus be used to pass data between respective sections, but with a plurality of sections sharing the same underlying physical storage unit 102. In other examples, though, the handling unit may allocate the storage so that each section writes to (and reads from) different physical storage than each other.

The first storage unit 102 in this case, comprising the storage elements 106-120 which are dynamically allocated to different sub-pipes, may be considered to correspond to a multi-pipe. In examples, a multi-pipe is mapped by the handling unit 720 to a unique physical storage location, which in this case is a unique storage unit 102. The physical storage location of a given multi-pipe does not overlap with the physical storage location of other multi-pipes (such as any other multi-pipe). However, a plurality of sub-pipes can be mapped to the same multi-pipe by the handling unit 720. The handling unit 720 can manage the mapping of the plurality of sub-pipes to the same physical storage location (the first storage unit 102 of FIG. 5), by managing the status of each of the sub-pipes in a given multi-pipe to avoid data being incorrectly overwritten and so forth.

To simplify execution of the task, various properties of sub-pipes may be the same for all sub-pipes of a given multi-pipe, such as a number of storage elements (and/or storage units) for a given sub-pipe, a storage unit and/or storage comprising the storage elements (such as whether the storage elements are within the accumulation buffer 736 or the shared storage 730), a start memory bank at which a given storage unit associated with the multi-pipe starts, a number of memory banks for the given storage unit, a start memory word for the given storage unit, a number of memory words for the given storage unit, and so on. However, at least one property may differ between sub-pipes of a multi-pipe, such as data specific parameters, e.g. the data values to be written to a given sub-pipe, a format of the data values, whether the data values are signed values and so forth.

The mapping of a plurality of sub-pipes to the same multi-pipe may be indicated by the task data. For example, as explained above, the handling unit 720 may determine from the operation-specific control data (and in some cases the storage-specific control data) of the task data whether to allocate different physical storage locations to correspond to different logical storage locations for a given connection in the directed graph represented by the task data.

In FIG. 5, the storage elements are dynamically allocated to different sub-pipes, each corresponding to a different respective set of storage elements. Dynamically allocating the storage elements in this way may mean that consecutive storage elements of a given set are not located contiguously with each other within the storage 100 (although this need not be the case in other examples). Storage elements of a first set may thus be interleaved with storage elements of a second set and vice versa. For example, at least one storage element of the second set may be disposed between a first storage element of the first set and a second storage element of the first set within the storage unit, such as the first storage unit 102 of FIG. 5. FIG. 5 shows such an example.

In FIG. 5, the first, third, fourth and sixth storage elements 106, 110, 112, 116 are successively allocated to a first set (shown without shading in FIG. 5). The second, fifth and seventh storage elements 108, 114, 118 are allocated to a second set (shown with dotted shading in FIG. 5). The eighth storage element 120 is unallocated and is shown with diagonal shading in FIG. 5. FIG. 5 therefore illustrates an example of non-contiguous first and second sets, with the second storage element 108 (of the second set) interleaved between the first and third storage elements 106, 110 (of the first set), and the sixth storage element 116 (of the first set) interleaved between the fifth and seventh storage elements 114, 118 (of the second set).

As at least one of the first and second sets of storage elements for storing first and second outputs of first and second operations of the directed graph, respectively, may include non-contiguous storage elements within the storage 100, it may not be sufficient to merely track the head and tail of the first and second sets in order to determine which storage elements are allocated to the first and second sets respectively.

Hence, in examples herein, the handling unit 720 is configured to track usage of the storage elements 106-120 during execution of the task, for example to track which storage elements are allocated to which sub-pipe, and in which order. The tracking of usage of the storage elements by the handling unit 720 allows the location of a given piece of data to be readily identified. This allows the data stored in a given physical storage location (which may be referred to as prior data, generated in a prior sub-operation of an operation) to be updated with subsequently generated data (which may be referred to as output data, generated in a sub-operation of the operation, which is executed after the prior sub-operation, such as consecutively after). In this way, the output data can be used to update the prior data stored in the physical storage location. For example, the prior data may be accumulated with the output data. This may be referred to as a destination loopback, involving a loopback over a destination pipe or sub-pipe. In this way, the execution circuitry can write to the destination pipe or sub-pipe, then return back to the start of that destination pipe or sub-pipe, and accumulate additional data into the output previously stored therein. Destination loopback may be performed in response to particular values of operation-specific control data and storage-specific control data as discussed further below.

### Example Uses of Operation-Specific Control Data

### First Example

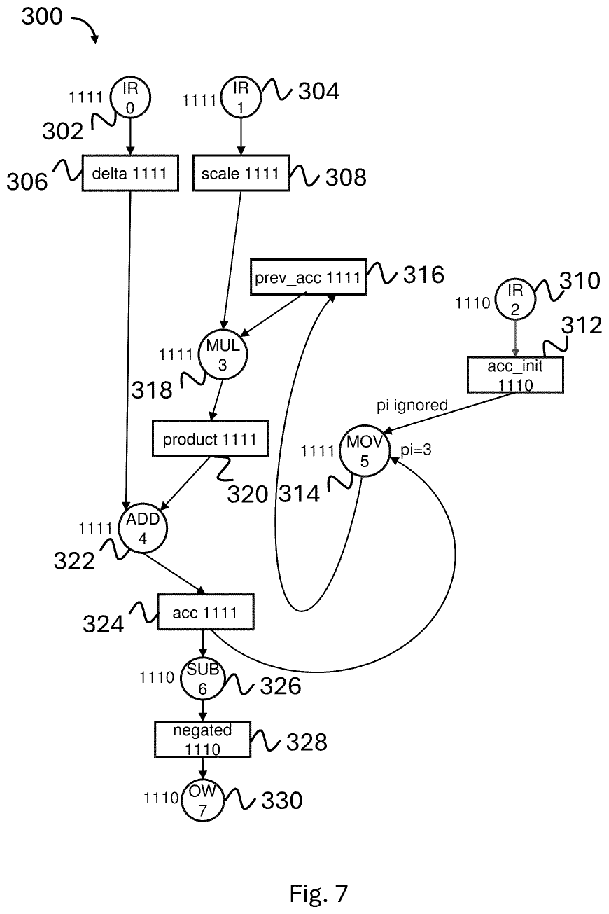

A first example use of operation-specific control data will now be described with reference to FIGS. 6 and 7. FIG. 6 shows a first table 200 of variables for the multi-dimensional nested loop. The multi-dimensional nested loop associated with the first table 200 of FIG. 6 may be expressed using the following pseudo-code:

```
for (i0 = 0; i0 < I0; i0 ++) {
  for (i1 = 0; i1 < I1; i1 ++) {
    for (m = 0; m < M; m ++) {
      acc = init_acc[i0, i1, m];
      for (n = 0; n < N; n ++) {
        product = acc * scale[i0, i1, m, n];
        acc = product + delta[i0, i1, m, n];
      }
      negate = −acc;
      result[i0, i1, m] = acc;
    }
  }
}
```

As can be seen from the first table 200, this nested loop is a loop over 4 dimensions (labelled from 0 to 3), with a variable i0 iterated over for dimension 0, a variable i1 iterated over for dimension 1, a variable m iterated over for dimension 2 and a variable n iterated over for dimension 3.

A second table 202 of FIG. 6 shows values of operation-specific control data and prior iteration control data for various operations of the nested loop. The nested loop includes the following operations (referred to as “sections” in the second table 202): IR 0 (a first input reader section comprising reading first input data), IR 1 (a second input reader section comprising reading second input data), IR 2 (a third input reader section comprising reading third input data), MUL 3 (a multiplication section comprising multiplication of two sets of input data), ADD 4 (an addition section comprising the addition of two sets of input data, MOV 5 (a move section comprising moving data to different storage), SUB 6 (a subtract section to subtract input data from 0) and OW 7 (an output writer section to write output data to storage). The numeral after each section indicates the order in which the sections are encoded in a data structure representing the task, which may be embodied by a neural engine program descriptor (NED).

The second table 202 includes the values of operation-specific control data expressed as values of elements of a dims_inc_run_mask for each dimension of the nested loop, labelled from 0 to 3 in the second table 202, and for each operation in the second table 202. These values will be described further with reference to FIG. 7.

The second table 202 also includes prior iteration control data, which may be comprised by the task data for a given operation. The prior iteration control data for example indicates a prior iteration dimension and may be used to signal that the operation comprises, in executing an iteration over a given dimension, usage of prior data generated in a prior iteration over the prior iteration dimension. For example, the prior iteration control data may indicate the dimension (referred to as the prior iteration dimension) for which reading of a prior iteration in that dimension is to be enabled for. The prior iteration dimension may be the given dimension (i.e. the prior data may be generated in a prior iteration over the same dimension that is currently being iterated over in executing the operation). In such cases, the handling unit may manage execution of the operation, using the execution circuitry, based on further on the prior iteration control data, for example to manage the execution of the operation to use the prior data accordingly. A given operation may use a plurality of sets of prior data. Hence, the task data may comprise a plurality of sets of prior iteration control data, each for a given set of prior data and/or the prior iteration control data may indicate a prior iteration dimension for each of a plurality of sets of prior iteration control data. In FIG. 6, the second table 202 includes prior iteration control data representing “Pi_inner” values for each section, indicating the prior iteration dimension, the values of which will be discussed further with reference to FIG. 7. If the source pipe and the destination pipe are the same (and are e.g. allocated to the same physical storage location of the storage by the handling unit, for example so that pointers to buffers for the source and destination pipes match), and the prior iteration control data indicates that iteration over the given dimension comprises usage of prior data generated by a prior iteration, this results in so-called destination loopback.

Reduction operations described herein support data transfer from one iteration to the next for a single section. Reduction operations do this by reading a destination pipe as an input from a previous iteration. The prior iteration control data may be used to instruct the handling unit to allow specified sections (e.g. specific operations) to access a source pipe as an input from a previous iteration of a production section (which may be referred to as a production operation) for that source pipe. This allows for feedback loops within a directed graph represented by a NED.

For example, a section may read from a previous iteration if the prior iteration dimension indicated by the prior iteration control data (e.g. in the form of at least one value denoting the prior iteration dimension in numerical form) is greater than 0. For example, the prior iteration control data may represent at least one of various values such as:
a pi_inner value indicating the prior iteration dimension. For example, for a multi-dimensional nested loop comprising 4 dimensions, pi_inner values of 1 to 4 indicate that executing the section uses prior data generated in iterations over the first to fourth dimensions respectively. A pi_inner value of 0 indicates that prior data is not to be used in executing the section.
a pi_inner_dimensions value referring to dimensions d with pi_inner<=d, i.e. a number of dimensions inward of the dimension for which prior data is used in executing the section. This range may be empty.
a pi_dimension value referring to a previous iteration dimension d=pi_inner-1. For this dimension, dims_inc_run_mask [d]==1.
a pi_outer_dimensions value referring to dimensions d with 0<=d< (pi_inner-1), i.e. a number of dimensions outward of the dimension for which prior data is used in executing the section. This range may be empty.

In this case, the handling unit may manage execution of the section to read from the previous iteration provided certain other requirements are satisfied. These other requirements may include at least one of the following:
That the operation supports usage of prior data from a prior iteration;
That if a value pi_src represented by the NED and indicative of a source pipe storing data to be used as an input to a given operation is equal to 0, a source pipe 0 for storing data to be used as prior data in a subsequent iteration must be present and reads the prior data from the prior iteration for the dimension pi_dimension referred to above; and
That if the value pi_src is equal to 1, a source pipe 1 for storing data to be used as prior data in a subsequent iteration must be present and reads the prior data from the prior iteration for the dimension pi_dimension referred to above.

When the handling unit issues a block (which is for example an operation-space block) to a section that reads from a prior iteration, there may be two cases: a first and second case as will now be described.

In the first case, the operation-space block is at the first position for the operation-space pi_dimension for which dims_inc_run_mask is set. In this case, initialization data for a source pipe indicated by pi_src is supplied in dependence on whether the type of the source pipe is indicated as being unused or initialization. If the source pipe is indicated as being an initialization pipe, then pi_src is equal to 0, and the source pipe 1 is read to provide the initialization data for the source pipe 0. The dims_inc_buf_mask must be 0 for the dimension pi_dimension and equal to the dims_inc_run_mask for other dimensions. Note that the source pipe 1 is only used for this initialization and is not read otherwise. If, however, the source pipe is indicated as not being an initialization pipe (e.g. if the source pipe is indicated as being unused), then pi_src is an optional source. In this case, the operation acts as if the optional source pipe is unused.

In the second case, the operation-space block is not at the first position for the dimension pi_dimension. Then the section reads the source pipe indicated by pi_src. The data is for the prior iteration in the pi_dimension.

In an example, pi_blocks is the number of operation-space blocks iterated by pi_inner_dimensions for which dims_inc_run_mask is set. This is one if dims_inc_run_mask [d] ==0 for all dimensions in pi_inner_dimensions. The section thus generates pi_blocks output buffers for blocks where the operation-space is at the first position for the dimension pi_dimension.

In some cases, a section reads from a prior iteration and the source pipe pi_src is equal to the destination pipe of the section. In these cases, the destination pipe must have at least pi_blocks buffers. If the destination pipe has exactly pi_blocks buffers, the handling unit can issue the block when the source pipe pi_src and the destination pipe are pointing to the same buffer of the storage, so as to support in-place update. This for example allows for destination loopback.

A third table 204 of FIG. 6 shows values of storage-specific control data expressed as values of elements of a dims_inc_buf_mask for each dimension of the nested loop, labelled from 0 to 3 in the third table 204, for various pipes of the nested loop, denoted “Delta”, “Scale”, “Acc_init”, “Prev_acc”, “Product”, “Acc” and “negated”. These values will be described further with reference to FIG. 7.

The nested loop for which various variables are shown in FIG. 6 is shown schematically in FIG. 7, and indicated with the reference numeral 300. This nested loop illustrates an example of so-called “loop carry dependencies”. In FIG. 7, the innermost and outermost loops of the nested loop (dimensions 3 and 0 respectively) correspond to the rightmost and leftmost values in the dims_inc_run_mask and dims_inc_buf_mask masks, with the second innermost and third innermost loops (dimensions 2 and 1 respectively) corresponding to the second rightmost and third rightmost values in these masks.

The nested loop 300 begins with two input reader operations (IR 0 and IR 1, labelled with reference numerals 302, 304 respectively) to read data from external memory and write to the pipes “delta” and “scale” respectively, 306, 308. These variables are accessed in the innermost loop of the nested loop (dimension 3), which is indicated by the IR 0 and IR 1 operations 302, 304 each having a dims_inc_run_mask value of 1111 (indicating that these operations are executed for each iteration over each of the dimensions from 0 to 3) and the pipes “delta” and “scale” 306, 308 each having a dims_inc_buf_mask value of 1111 (indicating that usage of the storage is iteration-dependent for each of the dimensions from 0 to 3. In this case, the combination of the dims_inc_run_mask value of 1111 and the dims_inc_buf_mask value of 1111 encodes the behavior that each dimension of the nested loop is to be iterated over and that each iteration over each dimension of the nested loop is associated with a different physical storage location of the storage, i.e. so each iteration of the innermost loop (dimension 3) comprises reading data from the “delta” pipe 306 from a different buffer per iteration, and each iteration of the innermost loop comprises reading data from the “scale” pipe 308 from a different buffer iteration. This is indicated in the pseudo-code as the accessing of the scale [i0, i1, m, n] and delta [i0, i1, m, n] values within the innermost loop.

A further input reader operation (IR 2, labelled with the reference numeral 310) is also performed to initialize an accumulator. The IR 2 operation 310 reads data from the pipe “acc_init” 312. The IR 2 operation 310 has a dims_inc_run_mask value of 1110 and the “acc_init” pipe 312 has a dims_inc_buf_mask value of 1110, encoding the behavior that each of dimensions 0 to 2 of the nested loop is to be iterated over and that each iteration over dimensions 0 to 2 of the nested loop is associated with a different physical storage location. However, as the value of the element of the dims_inc_run_mask and dims_inc_buf_mask masks is 0 for the innermost dimension (dimension 3) of the nested loop, and the “acc_init” pipe 312 is a source pipe to provide data to be input into another operation, this encodes the behavior that execution of the IR 2 310 operation is to be omitted (i.e. skipped) for the innermost dimension. This means that, within the innermost loop, there is not a new buffer for the “acc_init” pipe 312 for each iteration of the innermost loop. The execution of the IR 2 operation 310 to read data from the “acc_init” pipe 312 is indicated in the pseudo-code as the init_acc [i0, i1, m] value within dimension 2 of the nested loop.

The nested loop 300 comprises a move operation (MOV 5, labelled with the reference numeral 314), which is associated with prior iteration control data representing a “Pi_inner” value of 4 (indicating that executing this operation uses prior data generated in a prior iteration over the fourth dimension, which corresponds to a pi_dimension value of 3 (as there are four dimensions, labelled from 0 to 3, and pi_dimension represents the dimension label for the dimension for which prior data is used). The prior iteration control data is ignored for data read from the “acc_init” pipe in the innermost loop (indicated as “pi ignored” in FIG. 7), as the dims_inc_buf_mask value is 0 for the innermost loop (dimension 3). Since the previous iteration dimension (pi_dimension) is 3 (indicated by “pi=3” in FIG. 7), on the first iteration of dimension 3, the MOV 5 operation 314 reads the data from a source 1 pipe 312, “acc_init”. For iterations other than the first iteration of dimension 3, the MOV 5 operation 314 reads a source 0 pipe 324 “acc”, which is one iteration behind. The MOV 5 operation 314 comprises moving the data that is read to a “prev_acc” pipe 316, so as to store in the “prev_acc” pipe 316 an initialized value for the first iteration over the innermost loop and a previously accumulated value for iterations over the innermost loop after the first iteration. The “prev_acc” pipe 316 has a dims_inc_buf_mask value of 1111, indicating that a new buffer is associated with each iteration over each of the dimensions of the nested loop 300. This corresponds to the setting of “acc” equal to “init_acc [i0, i1, m]” for the first iteration of the innermost loop in the pseudo-code.

The nested loop 300 includes a multiply operation MUL 3 318, which is used to multiply the data stored in the “scale” pipe 308 with the data stored in the “prev_acc” pipe 316. The MUL 3 operation 318 has a dims_inc_run_mask value of 1111 which, in conjunction with the dims_inc_buf_mask values of 1111 for the “scale” 308 and “prev_acc” pipes 316 encodes the behavior that each dimension of the nested loop is to be iterated over and that each iteration over each dimension of the nested loop is associated with a different physical storage location of the storage.

The MUL 3 operation 318 writes data to a “product” pipe 320, which has a dims_inc_buf_mask value of 1111, indicating that each iteration over each dimension of the nested loop is associated with a different physical storage location of the storage, i.e. so that each multiplication performed by the MUL 3 operation 318 in iterating over the innermost loop generates data that is written to a different respective buffer. This corresponds to the execution of “product=acc * scale [i0, i1, m, n]” in the pseudo-code. A “Pi_inner” value represented by the prior iteration control data reserves a value of 0 to indicate that there is no prior iteration dimension (i.e. prior data is not used), meaning that dimensions are labelled using values from 1 upwards by the pi_inner value (whereas the dimensions themselves are labelled using values from 0 upwards). In this case, the MUL 3 operation 318 does not use prior data, and is thus associated with a “Pi_inner” value of 0.

The “product” pipe 320 and the “delta” pipe 306 are provided as source pipes to an ADD 4 operation 322 of the nested loop, which has a dims_inc_run_mask value of 1111. The ADD 4 operation 322 adds data stored in the “product” pipe 320 and the “delta” pipe 306 to generate data that is written to an “acc” pipe 324 as a destination pipe. The ADD 4 operation 322 is associated with prior iteration control data with a “Pi_inner” value of 0 as no prior data is used for this operation. The “acc” pipe 324 has a dims_inc_buf_mask value of 1111. The combination of these dims_inc_run_mask and dims_inc_buf_mask values encodes the behavior that each dimension of the nested loop is to be iterated over and that each iteration over each dimension of the nested loop is associated with a different physical storage location of the storage for both the source and the destination pipes. The ADD 4 operation 322 corresponds to the execution of “acc=product+delta [i0, i1, m, n]” in the pseudo-code.

The data stored in the “acc” pipe 324 is provided as an input to the MOV 5 operation 314, which is associated with prior iteration control data with a value (in this case, a “Pi_inner” value) of 4 indicating that the values stored in the “acc_init” 312 and “acc” 324 pipes are values of a prior iteration in dimension 3. However, as explained above, as the “acc_init” dims_inc_buf_mask value for the innermost dimension is 0, the prior iteration control data value of 4 is ignored for this source pipe, as the dims_inc_buf_mask value indicates that the “acc_init” pipe 312 is only read into the “prev_acc” pipe 316 for the first iteration over the innermost dimension. For subsequent iterations over the innermost dimension, data from the “acc” pipe 324 is moved into the “prev_acc” pipe 316 by the MOV 5 operation 314. This means that execution of the MUL 3 operation 318 in the subsequent iteration over the innermost dimension will multiply the data from the “acc” pipe 314 (corresponding to the previous iteration) that has subsequently been moved to the “prev_acc” pipe 316 by the MOV 5 operation 314.

The innermost loop is executed as described until each of the values from n=0 to n=N of the pseudo-code are iterated over. At this stage, the nested loop 3 includes a SUB 6 operation 326, which reads data from the “acc” pipe 324 as a source pipe, negates the data (i.e. subtracts the value represented by the data from 0 to get the negative of the value) and writes data to a “negated” pipe 328. The SUB 6 operation 326 has a dims_inc_run_mask value of 1110, indicating that this operation is performed for each iteration over each of dimensions 0 to 2 of the nested loop 300, but that execution of this operation is omitted for the innermost dimension of the nested loop 300. The “negated” pipe 328 has a dims_inc_buf_mask value of 1110, indicating that there is a new buffer in this pipe for each iteration over each of dimensions 0 to 2 of the nested loop 300 but no new buffer in this pipe for each iteration over the innermost dimension (dimension 3) of the nested loop 300 (in this case, because execution of the SUB 6 operation 326, which is the production operation to produce data for the “negated” pipe 328 is omitted for the innermost dimension). This corresponds to the “negate=−acc” step of the pseudo-code. The SUB 6 operation 326 is associated with a prior iteration control data value (in this case, a “Pi_inner” value) of 0, as no prior data is used for this operation. The SUB 6 operation 326 is performed for only the last iteration in dimension 3 and skips the “acc” pipe 324 input for iterations in dimension 3 other than the last iteration.

Finally, the nested loop includes an output writer operation, OW 7 330, which writes the data from the “negated” pipe 328 to storage. The OW 7 operation 330 has a dims_inc_run_mask value of 1110, indicating that the data from the “negated” pipe 328 is written to a different buffer for each iteration over each of dimensions 0 to 2 of the nested loop 300 and that no new buffer is written to storage for each iteration over the innermost dimension (dimension 3) of the nested loop 300. This corresponds to the “result [i0, i1, m]=acc” step of the pseudo-code. The OW 7 operation 330 is associated with a prior iteration control data value (in this case, a “Pi_inner” value) of 0, indicating that prior data is not used for this operation. The IR 0, IR 1 and IR 2 operations may be associated with prior iteration control data representing a pi_inner value of 0 (and, in some cases, a pi_num value of 0), as these operations do not use prior data from a prior iteration.

It can therefore be seen that in this example, for a given dimension, a value of dims_inc_run_mask that changes from 0 to 1 indicates that the first buffer generated for that dimension will be used as an input to the subsequent dimension (inwards of the given dimension in the nested loop 300). However, a value of dims_inc_run_mask that changes from 1 to 0 indicates that the last buffer generated for that dimension will be used as an input to the subsequent dimension (outwards of the given dimension in the nested loop 300). For example, the SUB 6 operation 326 skips over buffers that are produced in the accumulation of the value stored in the “acc” pipe 324 (i.e. the “acc=product+delta [i0, i1, m, n]” value, which is updated for each iteration of the innermost loop) and instead applies the subtract operation solely to the final buffer in the “acc” pipe 324, after the innermost loop has been iterated over. Hence, in this example, the “acc” pipe 324 is read at different rates by different operations: at a higher rate by the MOV 5 operation 314 (once per iteration over the innermost loop) and the SUB 6 operation 326 (once per completed execution of the innermost loop, i.e. once per iteration over the loop immediately outwards of the innermost loop). This results in the “acc” pipe 324 comprising buffers storing intermediate blocks (generated by iterations of the innermost loop prior to the final iteration) and final blocks (corresponding to the final result of the accumulation, at the end of a completed execution of the innermost loop, after each iteration of the innermost loop, dimension 3) has been completed for a given iteration in dimension 2). As explained above, the correct blocks to be read by a given operation, such as the MOV 5 operation 314 and the SUB 6 operation 326 may be identified by the handling unit in various manners, such as by using a dummy issue approach and/or other data structures to track the physical storage locations of various blocks in the storage.

FIG. 7 illustrates an example of a consumption operation (e.g. the MOV 5 operation 314) that comprises, for at least one iteration of a plurality of iterations over a given dimension of the plurality of dimensions, reading of an intermediate block of intermediate data values (and as the intermediate blocks stored in the “acc” pipe 324 for respective iterations over the innermost loop). Intermediate blocks such as this may be generated in iterating over a dimension determined based on the operation-specific control data. In this case, the operation-specific control data for the ADD 4 operation 322 indicates that the innermost loop is to be iterated over, to generate intermediate blocks for respective iterations over the innermost loop, which are stored in the “acc” pipe 324. The dimension determined based on the operation-specific control data (for which the intermediate blocks are generated) may correspond to the given dimension (for which the consumption operation is performed). Intermediate blocks may be generated by a production operation of the plurality of operations in determining a final block of final data values based on the intermediate block (such as a final block representing the final value of “acc=product+delta [i0, i1, m, n]” for the final iteration over the innermost dimension). In examples like this, the handling unit may be configured to manage execution of the operation, using the execution circuitry, based on the operation-specific control data, to allocate a physical storage location of the storage for storing the intermediate block, generate location data indicative of the physical storage location, generate execution instructions to instruct the execution circuitry to at least partly execute the production operation to generate the intermediate block in iterating over the dimension determined based on the operation-specific control data and to store the intermediate block in the physical storage location, the execution instructions comprising the location data, and send the execution instructions to the execution circuitry.

### Second Example

In a second example, operation-specific control data is used in executing a multi-dimensional nested loop comprising two loops with nested iterations: an n-loop performing an iterated sum and an m-loop, outwards of the n-loop within the nested loop, performing an iterated maximum between the sum generated upon completion of the n-loop and the previously-calculated maximum, in order to calculate the maximum of the sums of the (completed) n-loops. In this case, the sum (acc_sum) is calculated for each iteration of the innermost loop (the n-loop), the maximum (acc_max) is calculated for each iteration of the m-loop, but not for each iteration of the n-loop, and a result (result [i0, i1, m]) is stored for each iteration of an i1-loop, outwards of the m-loop. This may be expressed by the following pseudo-code:

```
for (i0 = 0; i0 < I0; i0 ++) {
  for (i1 = 0; i1 < I1; i1 ++) {
      acc_max = init_acc_max[i0, i1];
      for (m = 0; m < M; m ++) {
        acc_sum = init_acc_sum[i0, i1, m];
        for (n = 0; n < N; n ++) {
          acc_sum = acc_sum + delta[i0, i1, m, n];
        }
        acc_max = max(acc_max, acc_sum);
      }
      result[i0, i1, m] = acc_max;
  }
}
```

The following table gives an example mapping to a NED, with mask values in binary format with a dimension 0 (which is for example an outermost dimension) at bit 0 on the righthand side.

| | | | Dst0 pipe | Src0 pipe | Src1 pipe |
|---|---|---|---|---|---|
| Section | Operation | dims_inc_run_mask | (dims_inc_buf_mask) | (dims_inc_buf_mask) | (dims_inc_buf_mask) |
| IR | Load | 1111 | delta_pipe (111) | — | — |
| IR | Load | 0011 | init_acc_max_pipe | — | — |
| | | | (0011) | | |
| IR | Load | 0111 | init_acc_sum_pipe | — | — |
| | | | (0111) | | |
| VE | Mov | 0111 | previous_acc_max_pipe | acc_max_pipe (0111) | initial_acc_max_pipe |
| | | | (0111) | | (0011) |
| VE | Mov | 1111 | previous_acc_sum_pipe | acc_sum_pipe (1111) | initial_acc_sum_pipe |
| | | | (1111) | | (0111) |
| VE | Add | 1111 | acc_sum_pipe (1111) | previous_acc_sum_pipe | delta_pipe (1111) |
| | | | | (1111) | |
| VE | Max | 0111 | acc_max_pipe (0111) | previous_acc_max_pipe | acc_sum_pipe (1111) |
| | | | | (0111) | |
| OW | Store | 0011 | — | acc_max_pipe (0111) | — |

where IR refers to an input reader section, VE refers to a vector engine section, OW refers to an output writer section, Load refers to loading data (e.g. to read data in a particular pipe), Mov refers to a move operation, Add refers to an add operation, Max refers to the calculation of a maximum value, Store refers to writing data to storage, Dst0 pipe refers to a destination pipe, Src0 pipe refers to a first source pipe, Src1 pipe refers to a second source pipe and the names of the pipes corresponds to names of variables or functions of the pseudo-code but appended with “pipe”. Although not shown in the table, the Mov operation with a dims_inc_run_mask value of 0111 is associated with a pi_src value of 0 and prior iteration control data representing a pi_inner value of 3 and a pi_num value of 1 and the Mov operation with a dims_inc_run_mask value of 1111 is associated with a pi_src value of 0 and prior iteration control data representing a pi_inner value of 4 and a pi_num value of 1.

### Third Example

In a third example, operation-specific control data is used in executing a multi-dimensional nested loop comprising a dimension (the M dimension) which is split into two loops: an outer loop of m0 and an inner loop m1 of 4 blocks. The m1 loop is inside the n loop. Rather than having a single accumulator to which a delta value which is added to for each iteration of the M loop, there are four accumulators in the inner loop m1. Hence, in this case, the loop for which prior data is used to perform loop-carry dependency (the n loop) is not the innermost loop (which is the m1 loop). For example, data may be accumulated to a different buffer for each iteration of the innermost loop (e.g. to buffers 0 to 3). However, in iterating over each loop over n, the data is to be accumulated to the correct buffer for each iteration of the innermost loop (i.e. starting from buffer 0 rather than from buffer 3). In particular, the operation-specific control data (in this example, in conjunction with storage-specific control data and prior iteration control data) can be used by the handling unit in correctly managing the initialization of buffers 0 to 3 within the m1 loop for the first iteration over the n loop, the accumulation of the data within the m1 loop to the correct buffers for subsequent iterations over the n loop and the writing of data accumulated within the buffers in the m1 loop to further storage (as a “result_blk[i0, i1, m]” value) for the last iteration over the n loop. This is expressed as the dims_inc_run_mask having a value of 0 for an input reader (IR) operation for the second innermost loop (i.e. the n loop) corresponding to initializing the accumulator, as the initialization is only performed for the first iteration over the n loop. The dims_inc_run_mask also has a value of 0 for an output writer (OW) operation for the second innermost loop (i.e. the n loop) corresponding to writing the accumulation to the further storage, as the accumulation is only written to the storage for a single iteration over the n loop (the final iteration). The dims_inc_run_mask has a value of 1 for each of the operations in each of the other loops.

The third example may be expressed by the following pseudo-code:

```
for (i0 = 0; i0 < I0; i0 += B0) {
  for (i1 = 0; i1 < I1; i1 += B1) {
        for (m0 = 0; m0 < M; m0 += 4*BM) {
            for (n = 0; n < N ; n ++) {
                for (m1 = 0; m1 < 4*BM; m1 += BM) {
                    m = m0 + m1;
                    if (n == 0) { // first iteration
                      acc_blk[m1/BM] = initial_acc_blk[i0, i1, m];
                    }
                    acc_blk[m1/BM] = acc_blk[m1/BM] + delta_blk[i0, i1, m, n];
                    if (n == N−1) { // last iteration
                      result_blk[i0, i1, m] = acc_blk[m1/BM];
                    }
                  }
              }
          }
      }
    }
```

This example uses an iteration space of [i0, i1, m0, n, m1] and a block size of [B0, B1, 4*BM, 1, BM]. The acc_blk[4] array can map to an acc_blk pipe of 4, or more, buffers. The following table gives an example mapping to a NED, with mask values in binary format with a dimension 0 at bit 0 on the righthand side.

| | | | Dst0 pipe | Src0 pipe | Src1 pipe |
|---|---|---|---|---|---|
| Section | Operation | dims_inc_run_mask | (dims_inc_buf_mask) | (dims_inc_buf_mask) | (dims_inc_buf_mask) |
| IR | Load | 11111 | delta_pipe (11111) | — | — |
| IR | Load | 10111 | initial_acc_pipe | — | — |
| | | | (10111) | | |
| VE | Mov | 11111 | previous_acc_pipe | acc_pipe (11111) | initial_acc_pipe |
| | | | (11111) | | (10111) |
| VE | Mov | 11111 | acc_pipe (11111) | previous_acc_pipe | delta_pipe (11111) |
| | | | | (11111) | |
| OW | Store | 10111 | — | acc_pipe (11111) | — |

where the parameters in the table are the same as explained with reference to the second example. Although not shown in the table, the Mov operation is associated with prior iteration control data representing a value of 4.

### Fourth Example

In the fourth example, like the third example, an m dimension of a multi-dimensional nested loop is also split into two loops: an outer loop of m0 and an inner loop m1 of 4 blocks. The fourth example sums over dimension k using destination loopback and takes a rolling maximum in dimension n. This example involves loop-carry dependency operations, which are permitted to read and write to the same buffer. This for example allows in-place updates of the buffers. This may be expressed by the following pseudo-code:

```
for (m0 = 0; m0 < M; m0 += 4*BM) {
  for (n = 0; n < N; n ++) {
      for (k = 0 ; k < K ; k += BK) {
          for (m1 = 0; m1 < 4*BM; m1 += BM) {
                m = m0 + m1;
                if (k == 0) { // first k loop
                    if (n == 0) { // first n loop
                      max_blk[m1/BM] = −infinity;
                    }
                    acc_blk[m1/BM] = 0
                }
                acc_blk[m1/BM] += MatMul(A[m, k], B[k, n]);
                if (k + BK >= K) { // last k loop
                    max_blk[m1/BM] = max(max_blk[m1/BM], acc_blk[m1/BM]);
                    if (n + 1 >= N) { // last n loop
                        result_max_blk[m] = max_blk[m1/BM];
                    }
                  }
              }
            }
        }
    }
```

This example uses an iteration space of [m0, n, k, m1] and a block size of [4*BM, 1, BK, BM]. The acc_blk[4] array can map to an acc_blk pipe of 4 buffers. The max_blk[4] array can map to a max_blk pipe of 4 buffers. The following table gives an example mapping to a NED, with mask values in binary format with a dimension 0 at bit 0 on the righthand side.

| | | | Dst0 pipe | Src0 pipe | Src1 pipe |
|---|---|---|---|---|---|
| Section | Operation | dims_inc_run_mask | (dims_inc_buf_mask) | (dims_inc_buf_mask) | (dims_inc_buf_mask) |
| IR | Load | 1111 | A_pipe (1111) | — | — |
| IR | Load | 0111 | B_pipe (0111) | — | — |
| CE | MatMul | 1111 | product_acc_pipe | A_pipe (1111) | B_pipe (0111) |
| | | | (1111) | | |
| VE | Add | 1111 | acc_pipe (1111) | product_acc_pipe | acc_pipe (1111) |
| | | | | (1111) | |
| VE | Max | 1011 | max_pipe (1011) | acc_pipe (1111) | max_pipe (1011) |
| OW | Store | 1001 | — | max_pipe (1011) | — |

where the parameters in the table are the same as explained with reference to the second and third examples, CE refers to a convolution engine section and MatMul refers to a matrix multiplication operation. Although not shown in the table, the VE Add operation is associated with prior iteration control data representing a value of 3 and the VE Max operation is associated with prior iteration control data representing a value of 2.

The fourth example involves destination loopback, in which data stored in a destination pipe is re-accessed and updated for subsequent iterations of a loop (in this case to sum over a particular dimension, dimension k). To manage destination loopback, the handling unit in examples is configured to, based on operation-specific control data for an operation, determine that the operation is to be executed for each iteration of the plurality of iterations over a particular dimension of a multi-dimensional nested loop, the plurality of iterations comprising a first iteration and a second iteration, subsequent to the first iteration, allocate a plurality of storage elements of a physical storage location of the storage to correspond to a logical storage location and generate location data indicative of a location of a given storage element of the plurality of storage elements within the physical storage location. In this way, the handling unit can allocate storage for a connection in the directed graph associated with an output of the operation. By generating the location data, the location of the storage can be readily identified, for example to allow the data stored therein to be updated for subsequent iterations. For example, the handling unit in examples generates execution instructions, comprising the location data, to instruct the execution circuitry to, after execution of a prior sub-operation of the operation comprising storing prior data in the physical storage location, the prior sub-operation corresponding to the first iteration over the particular dimension: execute a sub-operation of the operation to generate output data, the sub-operation corresponding to the second iteration over the particular dimension, and use the output data to update data stored within respective storage elements of the plurality of storage elements according to a predefined order, starting from an initial storage element of the plurality of storage elements determined based on the location data, so as to update the prior data stored in the physical storage location using the output data. The handling unit may then send the execution instructions to the execution circuitry.

### Execution of Neural Engine Task

In the examples described herein, the neural engine's handling unit is responsible for iterating through operation-space for each section described in the NED graph. The handling unit uses the two masks, dims_inc_run_mask and dims_inc_buf_mask, to determine which increments are relevant and to correctly manage the dependencies between the sections and their pipes. Each section operates in its own local coordinate space, known as the section-space, and the handling unit is responsible for transforming each relevant operation-space block (relevant through an increment in a run dimension) into this section-space. In the examples described herein, this transformation may be programmatic and described with a small program in a specialized (or general purpose) ISA that is executed for each block before the section is invoked.

The handling unit may be synchronizing the execution of multiple different parts of these nested for-loops in parallel, and therefore needs to track where in the loop a function of a component should be invoked, and where in the loop, data that may be needed by subsequent components (based on the partially ordered set of data structures) is produced.

The execution of a neural engine task may be defined by two separate iterative processes implemented in the handling unit. In one process, the handling unit iteratively steps through the task's operation-space in block units as defined by the block size of the NED. In the other process, the handling unit iteratively steps through the dataflow graph defined by the NED (including the operation-specific control data and, in some cases, the storage-specific control data) and, where permitted by the dimension rules described above, transforms each block into the relevant section-space before invoking the section's execution unit with the transformed block by issuing invocation data.

In general, for most cases, these two processes are defined in the examples described herein to be architecturally independent. This means that the execution of any given block is defined definitively and completely in itself, in isolation of any other block or the state of the handling unit operation-space iteration. The execution of blocks that are not in accordance with this operation-space iteration and transformation will run to completion, but the results will not provide meaningful results with respect to full operation definitions of the Tensor Operator Set Architecture (TOSA).

In all cases, execution of a block must not extend beyond the block's section-space boundaries. Loading and storing of data (whether mapping the section-space to coordinates of a tensor in memory, to pipes, or any other memory or pipe storage) may extend beyond the section-space as required by an implementation's granularity of access, but must not extend beyond the size of a pipe's buffer. When the section-space is smaller than the pipe buffer, VE BlockReduce operations have an additional requirement to not modify the data in the buffer beyond the section space; no other operations or execution units have this requirement.

The TSU operation-space iteration may generate a block with one or more execution dimensions that are zero (execution_dimension_empty), meaning that no functional operation is required; this may occur due to padding before the start of operation-space or clipping at the end of operation-space, for example. As noted in TSU task iteration and block invocation, the block must still be dispatched to the execution unit for correct tracking of dependencies and execution ordering.

In this way, the following must hold for a transform to be valid for an operation-space to section-space transform to be compatible when connected by a pipe.

Assume the following scenario:
section S0 writes to a pipe P;
section S1 reads from the same pipe P;
T0( ) is the transform for section S0;
T1( ) is the transform for section S1;
B is a block in operation-space;
B0 is the absolute tensor coordinates of the block written to pipe P by S0;
This will be DST(T0(B)) where DST( ) is the fixed transform for S0's execution unit to its destination output space;
B1 is the absolute tensor coordinates of the block read from pipe P by S1;
This will be SRC(T1(B)) where SRC( ) is the fixed transform from S1's execution unit to its source input space.

Then the following must hold:
Compatible origin: Block B0 and block B1 must have the same lower bound coordinate for each dimension;
This coordinate forms the origin of the block stored in the pipe buffer;
Sufficient size: The size of block B0 must be greater or equal to the size of block B1 for each dimension.

The operation-space iteration may generate a block with one or more execution dimensions that are zero, meaning that no functional operation is required; this may occur due to padding before the start of operation-space or clipping at the end of operation-space, for example. The block must still be dispatched to the execution unit for correct tracking of dependencies and execution ordering.

To implement a reduction operation, the operation-space iteration will issue a sequence of block invocations to an execution unit (e.g. the convolution engine or vector engine) all targeting the same output block. The handling unit will signal when executing the first block in this sequence, and the execution unit must start by initializing the destination buffer (the whole buffer as limited by the block's size as described above), whereas for all subsequent blocks in the sequence the unit will read back the existing values from the buffer. In this way, the destination buffer acts as an additional input to the operation, from the perspective of individual block execution. In the case of the convolution engine, it is possible that one or more reduction dimensions are zero, meaning that no functional operation is required, but the convolution engine must still initialize the destination buffer if it is the first block in the sequence and the block's execution dimensions aren't empty.

When the handling unit invokes an execution unit to execute a block, the handling unit is configured to issue invocation data to execute the operation on a block. The block iteration is defined based on a block size specified in the NED and the issuance of the invocation data is done under the control of the dims_inc_run_mask (and in some cases the dims_inc_buf_mask and/or the prior iteration control data) as discussed above. Moreover, it is necessary for any dependencies that need to be met for the execution unit to operate on the block. These include that the required data is stored in the source pipe(s) for the operation and that sufficient storage is available in the destination pipe, as well as that the transform of the operation space to section space for that section has been performed and the output of that transform operation (i.e. the transformed coordinate data) is available to be issued to the execution unit. More specifically, it is to be ensured that there is sufficient availability in the pipe for a new block or buffer. However, this is not needed if this is not the first step in a reduction block, because in this instance the operation may involve simply read-modify-writing a previous destination block/buffer. Determining the availability of a source storage element may involve determining there is an appropriate block/buffer in the source pipe.

In an example, the invocation data comprises the output of the transform program in the form of transformed coordinates along with the relevant parts of the NED that describe that section (e.g. the configuration data from the sub-descriptor element of the NED for that section). This additional configuration data may also include the type of operation being performed (where the execution unit is able to perform more than one type of operation) and any other attributes of the operation, such as stride and dilation values in the example of a convolution operation.

The iteration process first involves reading from the NED a block size and iterating through the operation space one block at a time. For each block, a transform program is executed to transform the operation space coordinates to section space coordinates for that section. More detail on the transform programs is set out below. Once the section space coordinates have been determined, the section operation is performed in respect of that block. This process is iterated over all blocks until the operation is completed for all blocks.

### Programs and Systems for Implementing Examples Herein

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

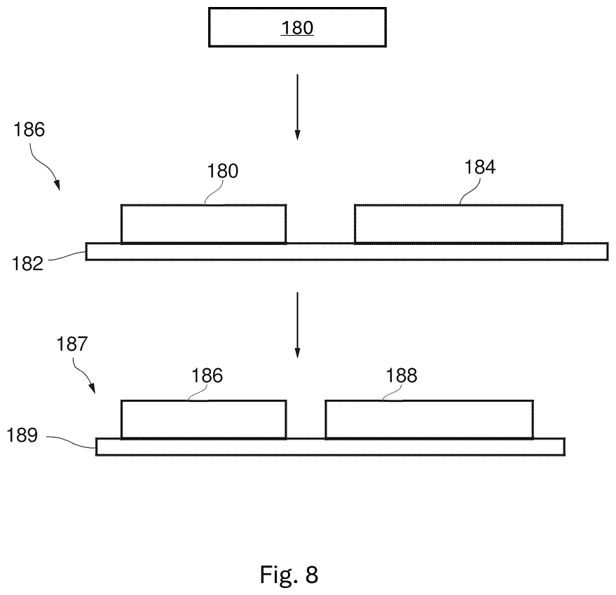

As shown in FIG. 8, one or more packaged chips 180, with the processor described above implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioral representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Examples

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

Further examples are set out in the following numbered clauses:
1. A processor comprising storage, execution circuitry and a handling unit, the handling unit configured to:
   obtain task data that describes a task to be executed, the task comprising a plurality of operations representable as a directed graph of operations comprising operations connected by connections corresponding to respective logical storage locations, wherein, in executing the task, the execution circuitry is configured to operate over a multi-dimensional nested loop, and wherein the task data comprises operation-specific control data for an operation of the operations, the operation-specific control data providing an indication, for each respective dimension of a plurality of dimensions of the multi-dimensional nested loop on a per-dimension basis, of whether the operation is to be executed for each iteration of a plurality of iterations over the respective dimension; and
   manage execution of the operation, using the execution circuitry, based on the operation-specific control data.
2. The processor of clause 1, wherein the operation-specific control data comprises a mask to provide the indication for each respective dimension of the plurality of dimensions.
3. The processor of clause 2, wherein the mask is a bit-wise mask comprising an element per dimension of the plurality of dimensions, a state of each element of the bit-wise mask providing the indication, on the per-dimension basis.
4. The processor of any one of clauses 1 to 3, wherein the task data comprises storage-specific control data for a connection between the operation and a further operation adjacent to the operation within the directed graph, wherein the storage-specific control data is configured to provide a further indication, for each respective dimension of the plurality of dimensions on a per-dimension basis, of whether usage of the storage is iteration-dependent.
5. The processor of clause 4, wherein the storage-specific control data comprises a further mask to provide the further indication for each respective dimension of the plurality of dimensions.
6. The processor of clause 5, wherein the further mask is a further bit-wise mask comprising an element per dimension of the plurality of dimensions, a state of each element of the further bit-wise mask providing the further indication, on the per-dimension basis.
7. The processor of any one of clauses 4 to 6, wherein, for a given dimension of the plurality of dimensions, a combination of the indication and the further indication encodes a behavior associated with the given dimension in executing the operation, the handling unit configured to manage execution of the behavior for the given dimension, using the execution circuitry, based on the operation-specific control data and the storage-specific control data.
8. The processor of clause 7, wherein the combination of the indication indicating that the given dimension is to be iterated over and the further indication indicating that the usage of the storage is iteration-dependent encodes the behavior that each iteration of the plurality of iterations is associated with a different respective physical storage location of the storage.
9. The processor of clause 7 or clause 8, wherein in response to the connection corresponding to a set of source logical storage locations, and to manage the execution of the behavior, based on the combination of the indication indicating that the given dimension is to be iterated over and the further indication indicating that usage of the storage is iteration-independent, the handling unit is configured to:
   map a source logical storage location of the set of source logical storage locations to the same source physical storage location for each iteration of iteration of the plurality of iterations; and
   instruct the execution circuitry to repeatedly re-read source data from the same source physical storage location in iterating over the given dimension.
10. The processor of any one of clauses 7 to 9, wherein in response to the connection corresponding to a set of destination logical storage location, and to manage the execution of the behavior, based on the combination of the indication indicating that the given dimension is to be iterated over and the further indication indicating that usage of the storage is iteration-independent, the handling unit is configured to:
   map a destination logical storage location of the set of destination logical storage locations to the same destination physical storage location for each iteration of the plurality of iterations;
   and instruct the execution circuitry to repeatedly write destination data to the same destination physical storage location in iterating over the given dimension.
11. The processor of any one of clauses 7 to 10, wherein in response to the connection corresponding to a set of source logical storage locations, and to manage the execution of the behavior, based on the combination of the indication indicating that iteration over the given dimension is to be omitted and the further indication indicating that usage of the storage is iteration-dependent, the handling unit is configured to:
   suppress execution of the operation, by the execution circuitry, for the given dimension for iterations prior to a final iteration of the plurality of iterations;
   map a source logical storage location of the set of source logical storage locations to a source physical storage location for the final iteration; and
   instruct the execution circuitry to execute the final iteration, comprising reading source data stored in the source physical storage location.
12. The processor of any one of clauses 7 to 11, wherein, to manage the execution of the behavior, based on the combination of the indication indicating that iteration over the given dimension is to be omitted and the further indication indicating that usage of the storage is iteration-independent, the handling unit is configured to:
   suppress execution of the operation, by the execution circuitry, for the given dimension.
13. The processor of any one of clauses 7 to 12, wherein in response to the connection corresponding to a set of source logical locations, to manage the execution of the behavior, based on the combination of the indication indicating that that the given dimension is to be iterated over and the further indication indicating that usage of the storage is iteration-dependent, the handling unit is configured to:
   map respective source logical storage locations of the set of source logical storage locations, corresponding to different respective iterations of the plurality of iterations, to different respective source physical storage locations; and
   instruct the execution circuitry to iterate over the given dimension, comprising reading source data stored in different respective source physical storage locations for each of the plurality of iterations.
14. The processor of any one of clauses 7 to 13, wherein in response to the connection corresponding to a set of destination logical locations, to manage the execution of the behavior, based on the combination of the indication indicating that that the given dimension is to be iterated over and the further indication indicating that usage of the storage is iteration-dependent, the handling unit is configured to:
   map respective destination logical storage locations of the set of destination logical storage locations, corresponding to different respective iterations of the plurality of iterations, to different respective destination physical storage locations; and
   instruct the execution circuitry to iterate over the given dimension, comprising, for each respective iteration of the plurality of iterations, writing data generated in executing the respective iteration to a different respective destination physical storage location.
15. The processor of any one of clauses 1 to 14, wherein the task data comprises prior iteration control data for the operation, the operation comprises, in executing an iteration over a given dimension of the plurality of dimensions, usage of prior data generated in a prior iteration over a prior iteration dimension indicated by the prior iteration control data, the prior iteration dimension being the given dimension, and the handling unit is configured to manage execution of the operation, using the execution circuitry, based further on the prior iteration control data.
16. The processor of any one of clauses 1 to 15, wherein:
   the operation is a consumption operation comprising, for at least one iteration of a plurality of iterations over a given dimension of the plurality of dimensions, reading of an intermediate block of intermediate data values;
   the intermediate block is generated, in iterating over a dimension determined based on the operation-specific control data, the dimension corresponding to the given dimension or a further dimension of the plurality of dimensions, outwards of the given dimension in the multi-dimensional nested loop, by a production operation of the plurality of operations in determining a final block of final data values based on the intermediate block; and
   to manage execution of the operation, using the execution circuitry, the handling unit is configured to, based on the operation-specific control data:
      allocate a physical storage location of the storage for storing the intermediate block;
      generate location data indicative of the physical storage location;
      generate execution instructions to instruct the execution circuitry to at least partly execute the production operation to generate the intermediate block in iterating over the dimension determined based on the operation-specific control data and to store the intermediate block in the physical storage location, the execution instructions comprising the location data; and
      send the execution instructions to the execution circuitry.
17. The processor of any one of clauses 1 to 16, wherein a connection associated with an output of an operation of the operations corresponds to a logical storage location and, to manage execution of the operation, using the execution circuitry, the handling unit is configured to, based on the operation-specific control data:
   determine that the operation is to be executed for each iteration of the plurality of iterations over a particular dimension, the plurality of iterations comprising a first iteration and a second iteration, subsequent to the first iteration;
   allocate a plurality of storage elements of a physical storage location of the storage to correspond to the logical storage location;
   generate location data indicative of a location of a given storage element of the plurality of storage elements within the physical storage location;
   generate execution instructions, comprising the location data, to instruct the execution circuitry to, after execution of a prior sub-operation of the operation comprising storing prior data in the physical storage location, the prior sub-operation corresponding to the first iteration over the particular dimension:
      execute a sub-operation of the operation to generate output data, the sub-operation corresponding to the second iteration over the particular dimension; and
      use the output data to update data stored within respective storage elements of the plurality of storage elements according to a predefined order, starting from an initial storage element of the plurality of storage elements determined based on the location data, so as to update the prior data stored in the physical storage location using the output data; and
      send the execution instructions to the execution circuitry.
18. A system comprising:
   the processor of any one of clauses 1 to 17, implemented in at least one packaged chip;
   at least one system component; and
   a board,
   wherein the at least one packaged chip and the at least one system component are assembled on the board.
19. A chip-containing product comprising the system of clause 18, wherein the system is assembled on a further board with at least one other product component.
20. A non-transitory computer-readable medium having stored thereon computer-readable code for fabrication of the processor of any one of clauses 1 to 17.

What is claimed is:

1. A processor comprising storage, execution circuitry and a handling unit, the handling unit configured to:
obtain task data that describes a task to be executed, the task comprising a plurality of operations representable as a directed graph of operations comprising operations connected by connections corresponding to respective logical storage locations, wherein, in executing the task, the execution circuitry is configured to operate over a multi-dimensional nested loop, and wherein the task data comprises operation-specific control data for an operation of the operations, the operation-specific control data providing an indication, for each respective dimension of a plurality of dimensions of the multi-dimensional nested loop on a per-dimension basis, of whether the operation is to be executed for each iteration of a plurality of iterations over the respective dimension; and
manage execution of the operation, using the execution circuitry, based on the operation-specific control data.

2. The processor of claim 1, wherein the operation-specific control data comprises a mask to provide the indication for each respective dimension of the plurality of dimensions.

3. The processor of claim 2, wherein the mask is a bit-wise mask comprising an element per dimension of the plurality of dimensions, a state of each element of the bit-wise mask providing the indication, on the per-dimension basis.

4. The processor of claim 1, wherein the task data comprises storage-specific control data for a connection between the operation and a further operation adjacent to the operation within the directed graph, wherein the storage-specific control data is configured to provide a further indication, for each respective dimension of the plurality of dimensions on a per-dimension basis, of whether usage of the storage is iteration-dependent.

5. The processor of claim 4, wherein the storage-specific control data comprises a further mask to provide the further indication for each respective dimension of the plurality of dimensions.

6. The processor of claim 5, wherein the further mask is a further bit-wise mask comprising an element per dimension of the plurality of dimensions, a state of each element of the further bit-wise mask providing the further indication, on the per-dimension basis.

7. The processor of claim 4, wherein, for a given dimension of the plurality of dimensions, a combination of the indication and the further indication encodes a behavior associated with the given dimension in executing the operation, the handling unit configured to manage execution of the behavior for the given dimension, using the execution circuitry, based on the operation-specific control data and the storage-specific control data.

8. The processor of claim 7, wherein the combination of the indication indicating that the given dimension is to be iterated over and the further indication indicating that the usage of the storage is iteration-dependent encodes the behavior that each iteration of the plurality of iterations is associated with a different respective physical storage location of the storage.

9. The processor of claim 7, wherein in response to the connection corresponding to a set of source logical storage locations, and to manage the execution of the behavior, based on the combination of the indication indicating that the given dimension is to be iterated over and the further indication indicating that usage of the storage is iteration-independent, the handling unit is configured to:
map a source logical storage location of the set of source logical storage locations to the same source physical storage location for each iteration of iteration of the plurality of iterations; and
instruct the execution circuitry to repeatedly re-read source data from the same source physical storage location in iterating over the given dimension.

10. The processor of claim 7, wherein in response to the connection corresponding to a set of destination logical storage location, and to manage the execution of the behavior, based on the combination of the indication indicating that the given dimension is to be iterated over and the further indication indicating that usage of the storage is iteration-independent, the handling unit is configured to:
map a destination logical storage location of the set of destination logical storage locations to the same destination physical storage location for each iteration of the plurality of iterations; and
instruct the execution circuitry to repeatedly write destination data to the same destination physical storage location in iterating over the given dimension.

11. The processor of claim 7, wherein in response to the connection corresponding to a set of source logical storage locations, and to manage the execution of the behavior, based on the combination of the indication indicating that iteration over the given dimension is to be omitted and the further indication indicating that usage of the storage is iteration-dependent, the handling unit is configured to:
suppress execution of the operation, by the execution circuitry, for the given dimension for iterations prior to a final iteration of the plurality of iterations;
map a source logical storage location of the set of source logical storage locations to a source physical storage location for the final iteration; and
instruct the execution circuitry to execute the final iteration, comprising reading source data stored in the source physical storage location.

12. The processor of claim 7, wherein, to manage the execution of the behavior, based on the combination of the indication indicating that iteration over the given dimension is to be omitted and the further indication indicating that usage of the storage is iteration-independent, the handling unit is configured to:
suppress execution of the operation, by the execution circuitry, for the given dimension.

13. The processor of claim 7, wherein in response to the connection corresponding to a set of source logical locations, to manage the execution of the behavior, based on the combination of the indication indicating that that the given dimension is to be iterated over and the further indication indicating that usage of the storage is iteration-dependent, the handling unit is configured to:
map respective source logical storage locations of the set of source logical storage locations, corresponding to different respective iterations of the plurality of iterations, to different respective source physical storage locations; and
instruct the execution circuitry to iterate over the given dimension, comprising reading source data stored in different respective source physical storage locations for each of the plurality of iterations.

14. The processor of claim 7, wherein in response to the connection corresponding to a set of destination logical locations, to manage the execution of the behavior, based on the combination of the indication indicating that that the given dimension is to be iterated over and the further indication indicating that usage of the storage is iteration-dependent, the handling unit is configured to:
map respective destination logical storage locations of the set of destination logical storage locations, corresponding to different respective iterations of the plurality of iterations, to different respective destination physical storage locations; and
instruct the execution circuitry to iterate over the given dimension, comprising, for each respective iteration of the plurality of iterations, writing data generated in executing the respective iteration to a different respective destination physical storage location.

15. The processor of claim 1, wherein the task data comprises prior iteration control data for the operation, the operation comprises, in executing an iteration over a given dimension of the plurality of dimensions, usage of prior data generated in a prior iteration over a prior iteration dimension indicated by the prior iteration control data, the prior iteration dimension being the given dimension, and the handling unit is configured to manage execution of the operation, using the execution circuitry, based further on the prior iteration control data.

16. The processor of claim 1, wherein:
the operation is a consumption operation comprising, for at least one iteration of a plurality of iterations over a given dimension of the plurality of dimensions, reading of an intermediate block of intermediate data values;
the intermediate block is generated, in iterating over a dimension determined based on the operation-specific control data, the dimension corresponding to the given dimension or a further dimension of the plurality of dimensions, outwards of the given dimension in the multi-dimensional nested loop, by a production operation of the plurality of operations in determining a final block of final data values based on the intermediate block; and
to manage execution of the operation, using the execution circuitry, the handling unit is configured to, based on the operation-specific control data:
allocate a physical storage location of the storage for storing the intermediate block;
generate location data indicative of the physical storage location;
generate execution instructions to instruct the execution circuitry to at least partly execute the production operation to generate the intermediate block in iterating over the dimension determined based on the operation-specific control data and to store the intermediate block in the physical storage location, the execution instructions comprising the location data; and
send the execution instructions to the execution circuitry.

17. The processor of claim 1, wherein a connection associated with an output of an operation of the operations corresponds to a logical storage location and, to manage execution of the operation, using the execution circuitry, the handling unit is configured to, based on the operation-specific control data:
determine that the operation is to be executed for each iteration of the plurality of iterations over a particular dimension, the plurality of iterations comprising a first iteration and a second iteration, subsequent to the first iteration;
allocate a plurality of storage elements of a physical storage location of the storage to correspond to the logical storage location;
generate location data indicative of a location of a given storage element of the plurality of storage elements within the physical storage location;
generate execution instructions, comprising the location data, to instruct the execution circuitry to, after execution of a prior sub-operation of the operation comprising storing prior data in the physical storage location, the prior sub-operation corresponding to the first iteration over the particular dimension:
execute a sub-operation of the operation to generate output data, the sub-operation corresponding to the second iteration over the particular dimension; and
use the output data to update data stored within respective storage elements of the plurality of storage elements according to a predefined order, starting from an initial storage element of the plurality of storage elements determined based on the location data, so as to update the prior data stored in the physical storage location using the output data; and
send the execution instructions to the execution circuitry.

18. A system comprising:
the processor of claim 1, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. A non-transitory computer-readable medium having stored thereon computer-readable code for fabrication of the processor of claim 1.
